(19) United States
(12) Patent Application Publication
(10) Pub. No.: US 2020/0133427 A1
(43) Pub. Date: Apr. 30, 2020

(54) DEVICE AND METHOD FOR GENERATING A THERMAL EFFECT WITH A DRIVING SIGNAL HAVING A KICK-IN PORTION AND/OR A BRAKING PORTION

(71) Applicant: IMMERSION CORPORATION, San Jose, CA (US)

(72) Inventors: Douglas BILLINGTON, Campbell, CA (US); David BIRNBAUM, Oakland, CA (US); Simon FOREST, Montreal (CA); Kaniyalal SHAH, Fremont, CA (US)

(21) Appl. No.: 16/175,638

(22) Filed: Oct. 30, 2018

(51) Int. Cl. G06F 3/041; F25B 21/04; G06F 3/01

(52) U.S. Cl. CPC G06F 3/0416; G06F 3/016; F25B 21/04

(57) ABSTRACT

A user interface device comprising a heat pump, a signal generating circuit, and a control circuit is presented. The control circuit is configured to control the signal generating circuit to generate a driving portion of a driving signal. All of the driving portion has a first polarity and causes the heat pump to generate the thermal effect, and causes heat flux to flow in a first direction. The control circuit is further configured to control the signal generating circuit to generate a braking portion of the driving signal, wherein all of the braking portion of the driving signal has a second polarity opposite the first polarity and causes the heat pump to stop the thermal effect.

### FIELD OF THE INVENTION

The present invention is directed to a device and method for generating a thermal effect with a driving signal having a kick-in portion and/or a braking portion, and has application in gaming, virtual reality and augmented reality, consumer electronics, automotive, entertainment, and/or other industries.

### BACKGROUND

Haptics provide a tactile and force feedback technology that takes advantages of a user's sense of touch by applying haptic effects, such as forces, vibrations, and other motions to a user. Devices such as mobile phones, tablet computers, and handheld game controllers can be configured to generate haptic effects. Haptic effects can include thermal effects, such as a heating effect that heats a part of the user's body, or a cooling effect that cools a part of the user's body.

### SUMMARY

One aspect of the embodiments herein relates to a user interface device comprising a heat pump, a signal generating circuit, and a control circuit. The heat pump is configured to generate a thermal effect at a surface of the user interface device when a driving signal is applied to the heat pump, wherein the thermal effect is at least one of a heating effect or a cooling effect. The signal generating circuit is configured to provide the driving signal to the heat pump. The control circuit is in communication with the signal generating circuit and configured to detect user contact on a portion of the surface of the user interface device, to determine, after the user contact is detected, that the thermal effect is to be generated at the surface, and to determine a target temperature or target heat flux associated with the thermal effect. The control circuit is further configured to control the signal generating circuit to generate a driving portion of the driving signal, wherein all of the driving portion has a first polarity and causes the heat pump to generate the thermal effect by generating heat flux between the heat pump and the portion of the surface of the user interface device, wherein the driving portion causes the heat flux to flow in a first direction, wherein the driving portion causes at least one of a temperature or a net heat flux at the portion of the surface of the user interface device to change away from a baseline temperature or baseline heat flux, respectively, and toward a target temperature or a target heat flux, respectively. The control circuit is further configured to detect, after the driving portion of the driving signal has begun being applied by the signal generating circuit to the heat pump, user contact being removed from the portion of the surface of the user interface device. The control circuit is further configured to control the signal generating circuit to generate a braking portion of the driving signal in response to detecting the user contact being removed from the portion of the surface, wherein all of the braking portion of the driving signal has a second polarity opposite the first polarity and causes the heat pump to stop the thermal effect by causing the heat flux between the heat pump and the portion of the surface to flow in a second and opposite direction, wherein the braking portion immediately follows the driving portion, and wherein the braking portion causes at least one of the temperature or the net heat flux at the portion of the surface of the user interface device to change away from the target temperature or the target heat flux, respectively, and toward the baseline temperature or the baseline heat flux, respectively.

### BRIEF DESCRIPTION OF THE DRAWINGS

The foregoing and other features, objects and advantages of the invention will be apparent from the following detailed description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIGS. 1A-1G depict embodiments of user interface device for generating a thermal effect, according to embodiments hereof.

FIGS. 2A and 2B depict a signal generating circuit applying driving signals to a thermoelectric device to generate thermal effects, according to embodiments hereof.

FIG. 3 depicts a driving signal that is applied to a thermoelectric device to generate a thermal effect, according to an embodiment hereof.

FIGS. 4 and 5 depict driving signals that each has a braking portion and a driving portion, wherein the driving portion has a sub-portion that acts as a kick-in portion, and wherein the driving signals are applied to a thermoelectric device to generate thermal effects, according to embodiments hereof.

FIG. 6 depicts a driving signal having a braking portion, wherein the driving signal is applied to a thermoelectric device to generate a thermal effect, according to an embodiment hereof.

FIGS. 7A-7C depict driving signals that each has a driving portion with a sub-portion acting as a kick-in portion, wherein the driving signals are applied to a thermoelectric device to generate thermal effects, according to embodiments hereof.

FIGS. 8 and 9 depict driving signals each having a magnitude with a series of steps that decrease in value, wherein the driving signals are applied to a thermoelectric device to generate thermal effects, according to embodiments hereof.

FIG. 10 provides a flow diagram illustrating a method of generating a driving signal for a thermal effect, according to an embodiment hereof.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

One aspect of the embodiments herein relates to generating a thermal effect, such as a heating effect or a cooling effect, at a surface of a user interface device, and more specifically to doing so in a manner that quickly starts the thermal effect and/or quickly stops the thermal effect, so as to provide a user interface device with a fast thermal response. Such a thermal effect may quickly heat or cool at least a portion of the surface of the user interface device. More generally speaking, such a thermal effect may provide a large heat flux to at least a portion of the surface of the user interface device. The heat flux may provide heat from a heat pump to the portion of the surface of the user interface device, or may draw heat away from the portion of the surface of the user interface device to the heat pump, depending on a direction of the heat flux. The heat flux that is generated by the heat pump may contribute to a net heat flux at the portion of the surface of the user interface portion, wherein the net heat flux may be a sum of the heat flux generated by the heat pump and a baseline heat flux caused by interaction between the user interface device and its surrounding environment, wherein the baseline heat flux may be zero in some instances and nonzero in other instances.

In an embodiment, when a user is in contact with a portion of the surface of the user interface device (e.g., via the user's hand or finger), the heat flux generated by the heat pump may flow to the user. For instance, when the heat flux generated by the heat pump is in a first direction, the heat flux may be a positive heat flux that provides heat from the heat pump to the surface of the user interface device, and then from the surface of the user interface device to the user. When the heat flux generated by the heat pump is in a second and opposite direction, the heat flux may be a negative heat flux that draws heat away from the surface of the user interface device and toward the heat pump, such that the surface of the user interface device in turn draws heat from the user. In an embodiment, a user may perceive the thermal effect by perceiving a temperature at the portion of the surface of the user interface device, and/or by perceiving heat flux between the user and the portion of the surface of the user interface device.

In an embodiment, the thermal effect of the embodiments herein may quickly change a temperature of a portion of the surface of the user interface device away from a baseline temperature value (also referred to as a preexisting temperature value, or just baseline temperature), and/or may quickly change a net heat flux of the portion of the surface of the user interface device away from a baseline heat flux value (also referred to as a preexisting heat flux value, or just baseline heat flux). In an embodiment, the thermal effect of the embodiments herein may cause the temperature or net heat flux to depart from a baseline value, and then quickly bring the temperature back to the baseline temperature value, and/or may quickly bring the net heat flux back to the baseline heat flux value. In some cases, the baseline temperature value of the portion of the surface of the user interface device may be a preexisting temperature value of a portion of the user's skin, if the user's skin has been in contact with the portion of the surface of the user interface device. In some cases, the baseline temperature value may be a preexisting room temperature, or, more generally, a preexisting temperature value of an environment surrounding the user interface device. In some cases, the baseline heat flux value may be, e.g., a preexisting heat flux value between the portion of the user interface device and a portion of the user's skin, or, more generally, a preexisting heat flux value between the portion of the user interface device and an environment immediately surrounding the user interface device.

In some cases, the thermal effect may be generated by a heat pump, such as a thermoelectric device (also referred to as a thermoelectric module, or TEM) or a fluid compressor, which may be configured to change or create heat flux between the heat pump and the surface of the user interface device in response to a driving signal to the heat pump. In an embodiment, the thermal effect may be quickly started by initially overdriving the heat pump (e.g., thermoelectric device) with a high voltage value V or high electrical current value I for a short period, so as to provide a high rate of temperature change or high magnitude of heat flux between the heat pump and the surface. More specifically, the overdriving may involve applying a driving signal that begins with a high value in magnitude. While the driving signal may subsequently settle to a lower value in magnitude, in order to avoid overheating the heat pump (e.g., thermoelectric device), the initial higher magnitude of the driving signal may shorten the overall amount of time needed to heat or cool the surface, in order to quickly achieve the thermal effect. The portion of the driving signal having the higher magnitude may be referred to as a kick-in portion, which is used to accelerate temperature change or to provide a high magnitude of heat flux between the heat flux and the surface of the user interface device. In some instances, the driving signal may begin with the kick-in portion, though in other instances the kick-in portion may be applied a short time period after the beginning of the driving signal. In some instances, the kick-in portion may have a magnitude that is higher than a specific voltage value or electrical current value (i.e., a value of an electrical current), as discussed below in more detail. In an embodiment, the driving signal may reverse in polarity in order to reverse a direction of the temperature change or reverse a direction of the heat flux between the surface and the heat pump. The portion of the driving signal having the reversed polarity may be referred to as a braking portion or inverse portion, and may be used to accelerate a return a temperature of the surface of the user interface device back toward the baseline temperature or to return a net heat flux at the surface to the baseline heat flux, in order to quickly stop the thermal effect.

In an embodiment, the kick-in portion and/or the braking portion may increase the availability of thermal effects and/or increase the sharpness of the thermal effects. For instance, if a thermal effect is generated with a driving signal that does not have a kick-in portion and a braking portion, the driving signal may have a magnitude with a low value(s). Although such a driving signal provides the advantage of minimizing the risk of overheating the heat pump (e.g., thermoelectric device), the amount of time needed to sufficiently heat or cool a surface of the user interface device or to achieve a particular heat flux value with such a driving signal may be on the order of tens of seconds, minutes, or tens of minutes. Further, when the driving signal ends, the amount of time for the surrounding environment of the user interface device to naturally cool or naturally heat the surface of the user interface device back to a baseline temperature value or baseline heat flux value may also be on the order of tens of seconds, minutes, or tens of minutes. As a result, the temperature change or heat flux change at the surface of the user interface device may not feel sharp. Further, after the user interface device has generated one thermal effect on its surface, it may have to wait tens of seconds, minutes, or tens of minutes for the surface of the user interface device to naturally return to the baseline temperature value or baseline heat flux value. During this time, the user interface device may be unable to generate another thermal effect. For instance, after the user interface device generates a cooling effect at the surface of the user interface device, it may have to wait a few minutes for the surface to naturally rise to the baseline temperature value again. During this time, a heating effect may be unavailable to the user interface device. Accordingly, the kick-in portion and/or the braking portion may be used to increase the sharpness of a thermal effect by increasing a rate of temperature change or to create a large magnitude in the heat flux, and may be used to increase the availability of thermal effects by more quickly returning the surface of the user interface device to a baseline temperature value or baseline heat flux, so that a subsequent thermal effect can be readily generated.

In an embodiment, a driving signal having the kick-in portion and/or braking portion may be used to generate a thermal effect at an outer surface or an inner surface of a user interface device. For instance, the user interface device may be a mobile phone or a handheld game controller, and the thermal effect may be generated at an outer surface of the user interface device. In another example, the user interface device may be a wearable device, and the thermal effect may be generated at an inner surface of the wearable device. More specifically speaking, the thermal effect is generated on at least a portion of a surface of the user interface device. The portion may be referred to as a thermal effect surface portion, and may be any portion of the surface of the user interface device, or may be a specific portion of the surface. In some cases, this specific location may be tied to a location of a heat pump (e.g., thermoelectric device). For instance, the thermal effect surface portion may be a portion of the surface that directly covers (e.g., disposed directly above) the thermoelectric device. In some cases, this thermal effect surface portion may also have to be in contact with the user's skin before a thermal effect is generated. In some cases, a virtual element may also be displayed at the thermal effect surface portion. For instance, the user interface device may be a mobile phone having a display device, and the mobile phone may be configured to display a virtual element, such as a virtual fire or virtual ice cube, at the thermal effect surface portion so that a thermal effect can be generated at that portion. In some cases, the thermal effect surface portion may be tied to a user input component. For instance, the user interface device may be a handheld game controller, and the thermal effect surface portion may be an outer surface of a trackpad or an outer surface of a trigger of the handheld game controller. In some cases, the thermal effect surface portion may be part of a display component, such as a head-mounted display for use in virtual reality, augmented reality, and/or other forms of mixed reality. In some cases, the thermal effect surface portion may be part of a tangible “proxy” device or object that has interactive qualities when incorporated into a virtual environment. In some cases, the thermal effect surface portion may be part of a wearable device that is attached or embedded in a user's clothing, jewelry, shoes, or other apparatus worn on the user's body.

In an embodiment, the thermal effect may be triggered by an application, such as a virtual reality (VR) or an augmented reality (AR) application. The VR or AR application may be executing on the user interface device, or may be executing on a computing device in communication with the user interface device. In an embodiment, the VR or AR application may specify a target temperature or target heat flux (also referred to as a target temperature value or target heat flux value) for the thermal effect. The target temperature may be equal to, e.g., a temperature value assigned to a virtual element of the VR or AR application. The target heat flux may be equal to, e.g., a value of a heat flux to be simulated between the user and the virtual element. In some cases, the thermal effect may be controlled so that a net heat flux at a thermal effect surface portion reaches the target heat flux. In some cases, the thermal effect may be controlled so that a heat flux generated by the heat pump reaches the target heat flux. In an embodiment, the thermal effect may be generated when a user is interacting with the virtual element via the user interface device, and thus may enhance the realism of that interaction. In an embodiment, the thermal effect is a feed-forward effect where the change in heat flux serves to notify the user of incoming information.

In an embodiment, the thermal effect may change a temperature at a portion of the surface of the user interface device (e.g., the thermal effect surface portion), and/or change a heat flux between the thermal effect surface portion and an object (e.g., a user's finger) in contact with the thermal effect surface portion. In some cases, the thermal effect may change the heat flux between the object and the thermal effect surface portion without changing the temperature at the thermal effect surface portion. For instance, the object may be drawing heat away from the thermal effect surface portion at the same rate at which a heat pump is providing heat to the thermal effect surface portion. In such a situation, there is a nonzero heat flux from the heat pump to the thermal effect surface portion, and from the thermal effect surface portion to the object, but the temperature of the thermal effect surface portion may remain substantially unchanged. In other cases, the temperature of the thermal effect surface portion may change when the heat pump generates a heat flux between itself and the thermal effect surface portion. A user may perceive the thermal effect by perceiving the change in temperature at the thermal effect surface portion and/or the change in heat flux between the thermal effect surface portion and the user. For instance, when the thermal effect surface portion is at a temperature that is equal to or higher than a temperature of the user's skin, the user may be better able to feel or otherwise perceive a temperature of the thermal effect surface portion. When the thermal effect surface portion is at a temperature that is lower than the temperature of the user's skin, the user may be better able to feel the heat flux between the user and the thermal effect surface portion.

In an embodiment, a timing of the thermal effect, and more specifically of a driving signal for generating the thermal effect, may be fixed in duration and/or magnitude. For instance, the driving portion and the braking portion may each have a respective defined duration. In an embodiment, a timing of the driving signal may be based on user contact with the surface of the user interface device. For instance, the user interface device may refrain from generating the thermal effect unless the surface of the user interface is experiencing user contact at any location on the surface, or at a specific location of the surface. Moreover, the user interface device may stop the thermal effect, via a braking portion, as soon as user contact is removed from all of the surface of the user interface device, or from a specific portion of the surface of the user interface device.

In an embodiment, the driving signal for the thermal effect may be controlled via open loop control or closed loop control. In some cases, the open loop control may rely on a temperature control profile that associates target temperatures (also referred to as target temperature values) with respective voltage values or respective electrical current values, and/or rely on a heat flux control profile that associates target heat fluxes (also referred to as target heat flux values) with respective voltage values or respective electrical current values. In some cases, the thermal effect may be controlled so that a net heat flux at a thermal effect surface portion reaches the target heat flux. In some cases, the thermal effect may be controlled so that a heat flux generated by the heat pump reaches the target heat flux. In an embodiment, the heat flux generated by a heat pump such as a Peltier device may have a value that is proportional to a electrical current value I. In one scenario, if the thermal effect has a target temperature or target heat flux, the driving signal for the thermal effect may have a kick-in portion that exceeds in magnitude the voltage value V or electrical current value I associated with the target temperature in the temperature control profile or with the target heat flux in the heat flux control profile, and the driving signal may subsequently settle to the associated voltage value or electrical current value I. In some cases, the closed loop control may control the driving signal based on sensor data from a temperature sensor, heat flux sensor, or other sensor or any combination of these sensors.

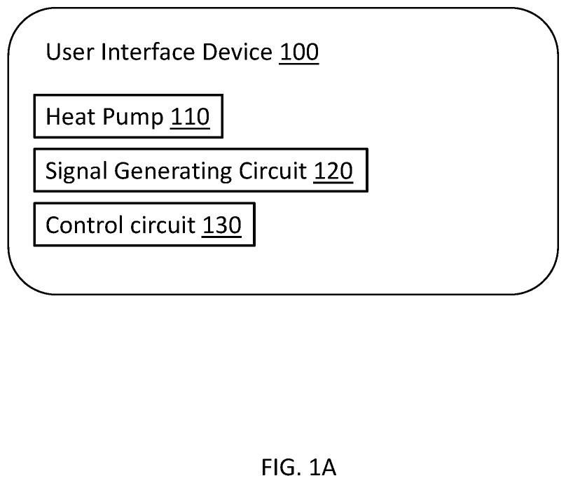

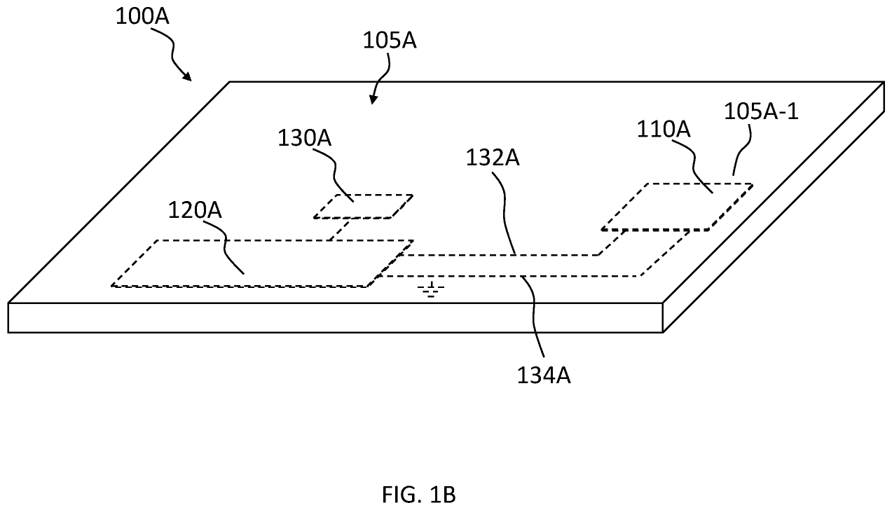

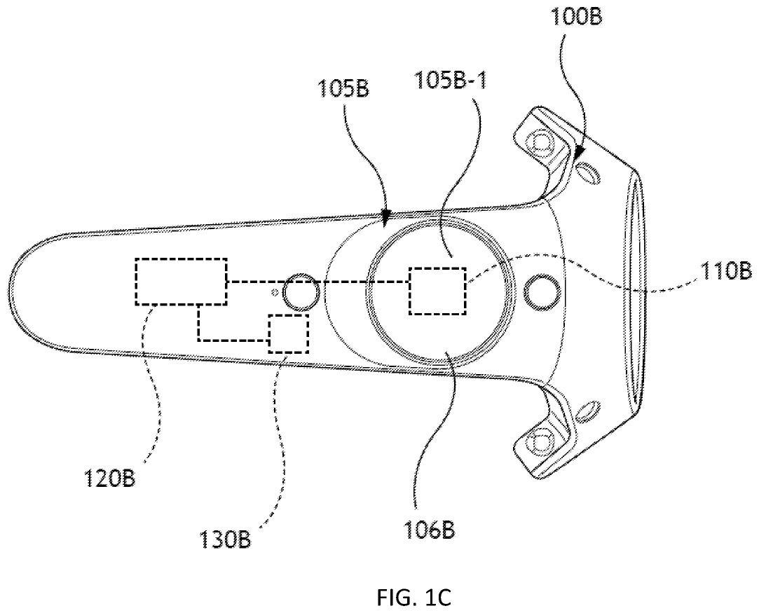

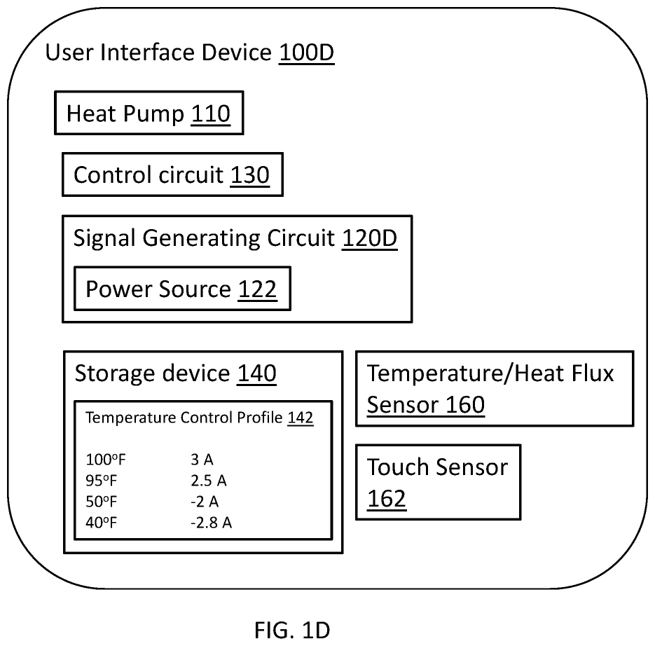

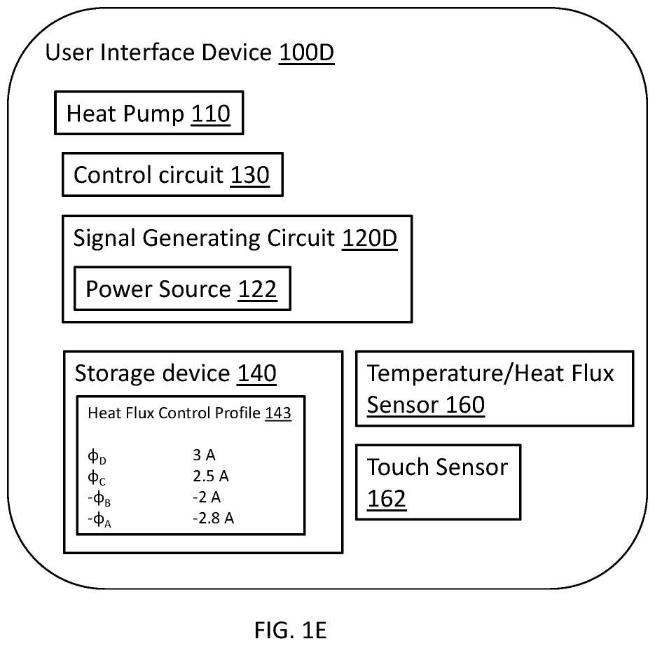

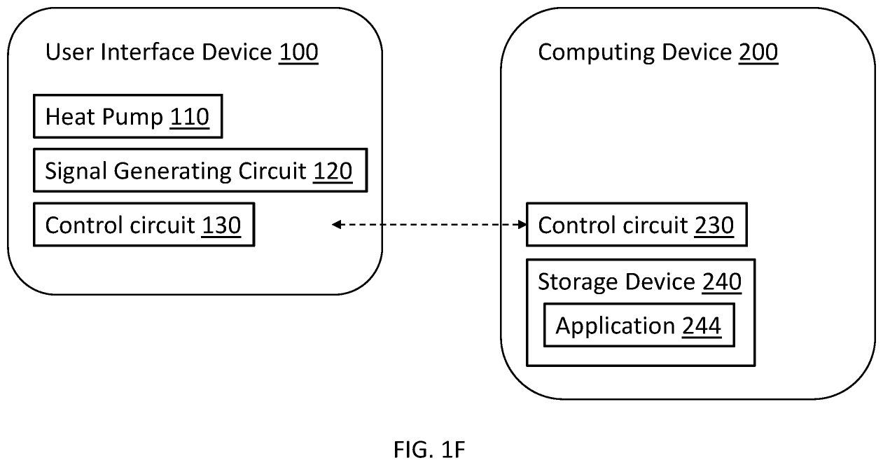

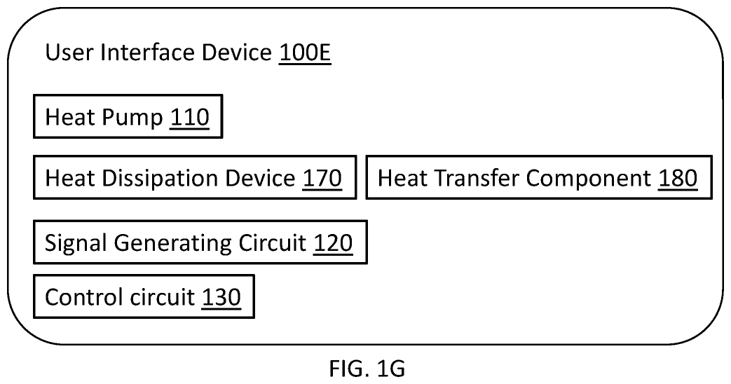

FIG. 1A provides a block diagram that illustrates a user interface device 100 that is configured to generate a thermal effect, which includes at least one of a heating effect or a cooling effect. The user interface device 100 may be a mobile phone, a tablet computer, a laptop computer, a handheld game controller, a wearable device (e.g., a glove or a head-mounted device), or any other user interface device. As depicted in the figure, the user interface device 100 includes a heat pump 110, a signal generating circuit 120, and a control circuit 130.

In an embodiment, the heat pump 110 may be configured to generate a heat flux between the heat pump 110 and at least a portion of a surface of the user interface device 100, wherein the portion may be referred to as a thermal effect surface portion. The heat flux, which is also referred to as a thermal flux, may refer to a flow of energy (e.g., a heat flow) in a particular direction, and may have units of watts per square meter or some other unit. The heat flux between the heat pump 110 and another element (e.g., the thermal effect surface portion) may refer to heat flux from the heat pump 110 to that element (this may be referred to as a positive heat flux being applied to the element), or heat flux from that element to the thermoelectric device (this may be referred to as a negative heat flux being applied to the element). In the embodiments herein, a heat flux at the surface of the user interface device 100 that is in a first direction may be referring to heat being provided to the surface in order to heat the surface, while the heat flux being in a second and opposite direction may be referring to heat being absorbed from the surface in order to cool the surface. For instance, the heat pump may have a first side that is closer to the thermal effect surface portion, and a second side that is farther from the thermal effect surface portion, and may generate heat flux that is in a first direction from the second side to the first side of the heat pump. This first direction also points from the heat pump to the thermal effect surface portion. As a result, the heat flux in the first direction causes heat to flow from the heat pump 110 to the thermal effect surface portion. In some cases, the thermal effect surface portion may increase in temperature as a result of the heat flux in the first direction. In other cases, the thermal effect surface portion may remain substantially the same in temperature even with the heat flux in the first direction, because, e.g., an object in the environment of the thermal effect surface portion may absorb the heat therefrom before the heat can increase the temperature of the thermal effect surface portion. In another example, the heat pump may generate a heat flux that is in a second and opposite direction, from the first side of the heat pump to the second side of the heat pump. The second direction also points from the thermal effect surface portion to the heat pump. As a result, the heat flux in the second direction causes heat to flow from the thermal effect surface portion to the heat pump, such that heat is drawn away from the thermal effect surface portion. In some cases, the thermal effect surface portion may decrease in temperature as a result of the heat flux in the second direction. In other cases, the thermal effect surface portion may remain substantially the same in temperature even with the heat flux in the second direction because, e.g., an object in the environment of the thermal effect surface portion may be providing external heat to the thermal effect surface portion. The direction of the heat flux may also be referred to as a heat flux direction, and a direction of the temperature change (if any) may be referred to as a temperature change direction. As discussed in more detail below, the heat flux direction for the heat flux between the heat pump and the thermal effect surface portion may be based on a polarity of a driving signal being used to drive the heat pump. In an embodiment, the temperature change may be based on the polarity of the driving signal being used to drive the heat pump 110.

In some cases, the thermal effect surface portion may have a baseline heat flux or preexisting heat flux between itself and its external environment, before any additional heat flux is generated by the heat flux. In such cases, the heat flux that is generated by the heat pump 110 may be added to the baseline heat flux to create a net heat flux at the thermal effect surface portion, which may also be referred to as a total heat flux or more simply as the heat flux at the thermal effect surface portion. For instance, if the baseline heat flux is −Φ₁, and the heat pump generates a heat flux of Φ₂, then the heat flux at the thermal effect surface portion may change from being −Φ₁ to being Φ₂−Φ₁.

In an embodiment, the heat pump 110 may be a thermoelectric device, such as a Peltier device. The Peltier device may, e.g., be formed from two dissimilar metals or two dissimilar semiconductors (e.g., n-type semiconductor and p-type semiconductor). The two dissimilar metals or the two dissimilar semiconductors may create the Peltier effect at a junction between them. When a voltage difference between the two dissimilar metals or two dissimilar semiconductors causes electrical current to flow from one of the dissimilar materials to the other of the dissimilar materials, heat may flow from a first side of the Peltier device to a second and opposite side thereof. For instance, the first side may become hotter, while the second side may become cooler. If the voltage difference and/or the electrical current reverses in polarity, heat may flow in an opposite direction. As a result, the first side may become cooler, while the second side may become hotter. Peltier devices are discussed in more detail in U.S. patent application Ser. No. 15/156,910, entitled “Thermally Activated Haptic Output Device,” the entire content of which is incorporated herein by reference.

In an embodiment, the heat pump 110 may include a pump and an airtight container, such as a container of pressurized carbon dioxide (CO₂) or other gas. When a voltage difference having a first polarity (e.g., a positive voltage difference) is applied across two terminals of the pump (e.g., the positive terminal and negative terminal), the pump may compress the CO₂ gas, which may cause a temperature of the gas in the container to increase. The container may be made from a conductive material, such as metal, that is able to conduct heat from the temperature increase to another element, such as the thermal effect surface portion, in order to provide a heating effect thereto. When the voltage difference has a second and opposite polarity (e.g., a negative voltage difference), the pump may cause the CO₂ to expand or otherwise decrease in pressure in the container, which may cause a temperature of the gas in the container to decrease, thus making the gas colder. The colder gas may absorb heat from the thermal effect surface portion, and thus may provide a cooling effect to the thermal effect surface portion. The use of gas compression to generate heating or cooling is also discussed in more detail in U.S. patent application Ser. No. 15/156,910.

In an embodiment, the signal generating circuit 120, which may also be referred to as a driving circuit, may be configured to generate a voltage signal, a current signal, or other driving signal to drive the heat pump 110. In some instances, the signal generating circuit 120 may be controlled by the control circuit 130, and may generate a driving circuit that is specified by the control circuit 130. For instance, the control circuit 130 may communicate a digital or analog control signal to the signal generating circuit 120 that specifies a waveform for the driving signal, how a magnitude of the driving signal is to change over time, a duration of the driving signal, or some other characteristic of the driving signal. The signal generating circuit 120 may be configured to generate the driving signal based on the control signal, and then apply the driving signal to the heat pump 110. In an embodiment, the control signal may be a digital version and/or a low-magnitude version of the driving signal, and the signal generating circuit 120 may be configured to amplify the control signal and/or perform digital-to-analog conversion on the control signal, wherein a result of the amplification and/or conversion may be a driving signal that can be applied to the heat pump 110.

In an embodiment, the control circuit 130 may be a microprocessor, an application specific integrated circuit (ASIC), field programmable logic array (FPGA), or programmable logic array (PLA). The control circuit 130 may dedicated to controlling haptic effects for the user interface device 100, or may be, e.g., a general purpose microprocessor that is configured to control other functionality of the user interface device 100.

FIG. 1B illustrates a user interface device 100A that is an embodiment of the user interface device 100. The user interface device 100A may be, e.g., a mobile phone or a tablet computer. The user interface device 100A includes a heat pump 110A, a signal generating circuit 120A, and a control circuit 130A. In an embodiment, the heat pump 110A, signal generating circuit 120A, and control circuit 130A may be disposed within a space enclosed by a housing of the user interface device 100A, wherein the housing may include the combination of a shell that forms a back side of the user interface device 100A and a display device that forms a front side of the interface device 100A. The outer surface of the housing may form an outer surface 105A of the user interface device 100A. In an embodiment, the heat pump 110A may be configured to provide heat flux between itself and at least a portion 105A-1 of the outer surface 105A of the user interface device 100A, wherein the portion 105A-1 may also be referred to as a thermal effect surface portion 105A-1. In an embodiment, the thermal effect surface portion 105A-1 may be a portion of the surface 105A that directly covers the heat pump 110A. For instance, the heat pump 110A may be in contact a portion of the housing whose outer surface forms the thermal effect surface portion 105A-1 (the heat pump 110A may be in contact with an inner surface of that portion of the housing). The heat pump 110A may be configured to create a heat flux between itself and the thermal effect surface portion 105A-1, such that heat flows from the heat pump 110A to the thermal effect surface portion 105A-1, or such that heat flows from the thermal effect surface portion 105A-1 to the heat pump 110A. When a finger or other part of a user is in contact with the thermal effect surface portion 105A-1, the user may perceive the heat flux, and may perceive any change in temperature of the thermal effect surface portion.

As illustrated in FIG. 1B, the heat pump 110A may be driven by the signal generating circuit 120A. More specifically, the signal generating circuit 120A may provide a driving signal to the heat pump 110A via a first terminal 132A and a second terminal 134A. As discussed above, the driving signal that is generated by the signal generating circuit 120A may be controlled by the control circuit 130A.

FIG. 1C depicts a user interface device 100B that is an embodiment of the user interface device 100. More specifically, the user interface device 100B may be a handheld game controller for providing user input to an application, such as a VR or AR application. The user interface device 100B may include a heat pump 110B, a signal generating circuit 120B, and a control circuit 130B. In an embodiment, the user interface device 100B may have a plastic shell that forms a housing of the user interface device 100B, and may have one or more mechanical user input components, such as trackpad 106B or a trigger, attached to the housing. An outer surface of the housing and the respective outer surfaces of the one or more mechanical user input components may together form an outer surface 105B of the user interface device 100B. The heat pump 110B, the signal generating circuit 120B, and the control circuit 130B may be disposed within the housing.

In FIG. 1C, the signal generating circuit 120B may be in communication with the control circuit 130B, and may be controlled by the control circuit 120B to generate a driving signal and apply the driving signal to the heat pump 110B. In an embodiment, the heat pump 110B, when driven by the driving signal, may be configured to generate at least one of a heating effect or a cooling effect at a portion 105B-1 of the outer surface 105B of the user interface device 100B, wherein the portion 105B-1 may be referred to as a thermal effect surface portion 105B-1. In the embodiment of FIG. 1C, the thermal effect surface portion 105B-1 may be an outer surface of the trackpad 106B, wherein the outer surface of the trackpad 106B directly covers the heat pump 110B. The heat pump 110B may be configured to create a heat flux between itself and the thermal effect surface portion 105B-1, and more specifically a heat flux at the thermal effect surface portion 105B that is toward or away from the heat pump 110B. In some situations, the heat flux may heat or cool the trackpad 106B, depending on the direction of the heat flux.

FIG. 1D depicts a user interface device 100D that is also an embodiment of the user interface device 100. Like in FIG. 1A, the user interface device 100D includes the heat pump 110 and control circuit 130. In the embodiment of FIG. 1D, the signal generating circuit 120D includes a power source 122, such as a battery, that provides power for generating a driving signal. In some cases, the signal generating circuit 120D may further include other components, such as a signal amplification circuit or a digital to analog converter (DAC).

The user interface device 100D may further include a storage device 140 (e.g., computer memory, such as a hard disk drive (HDD), a solid state drive, or dynamic random access memory (DRAM)). In an embodiment, the storage device 140 may store a temperature control profile 142, and the driving signal may be generated based on the temperature control profile 142. The temperature control profile 142 may be, e.g., a table or other data structure that associates target temperatures with respective voltage values or respective electrical current values. For instance, if a thermal effect has a target temperature, then the driving signal may be generated based on a voltage value or electrical current value associated with the target temperature in the temperature control profile 142. The respective voltage values or respective electrical current values may have been experimentally determined to be able to change a temperature of an element (e.g., a surface portion) via a thermoelectric device from a defined baseline temperature to respective target temperatures within a defined, fixed time interval. For instance, the time interval may be 15 seconds, and it may have been experimentally determined that a electrical current value of 3 A, when applied to a thermoelectric device, will cause the thermoelectric device to heat an adjacent element from a defined baseline temperature (e.g., 70° F.) to a first target temperature of 100° F. in the time interval. In this example, it may also have been experimentally determined that electrical current values of 2.5 A, −2 A, and −2.4 A, cause the thermoelectric device to heat or cool the adjacent element from the defined baseline temperature to a second target temperature of 95° F., a third target temperature of 50° F., and a fourth target temperature of 40° F., respectively, in the time interval. These values may then have been programmed into the temperature control profile, and then loaded to the storage device 140. In an embodiment, if a thermal effect has a target temperature, then the driving signal may be based on a voltage value or electrical current value associated with the target temperature in the temperature control profile. For instance, the driving signal may then be generated such that at least a portion thereof is at the voltage value or electrical current value of associated with the target temperature. In an embodiment, the voltage values or electrical current values in the temperature control profile 142 may be referred to as steady state voltage values or steady state electrical current values. FIG. 1E is similar to FIG. 1D, but depicts the storage device 140 of the user interface device 100D storing a heat flux control profile 143. In an embodiment, the heat flux control profile 143 may define a relationship between a voltage value or electrical current value that is applied to the heat pump 110 and a heat flux value that is generated by the heat pump 110. The heat flux value may refer to a heat flux generated by the heat pump 110, or to a net heat flux at the thermal effect surface portion.

In an embodiment, the storage device 140 may store computer-executable instructions, such as instructions for a VR application or AR application, or instructions to control the generating of a thermal effect, including instructions to perform the steps described herein. In an embodiment, the storage device 140 may be a hard disk drive (HDD), a solid state drive, or any other non-transitory computer-readable medium.

As further depicted in FIGS. 1D and 1E, the user interface device 100D further includes a temperature and/or a heat flux sensor 160. The temperature/heat flux sensor 160 may be configured to measure the mean temperature at a portion of a surface of the user interface device, such as a thermal effect surface portion, or measure heat flux at the thermal effect surface portion. In an embodiment, the temperature/heat flux sensor 160 may include multiple sensing elements that are disposed at different regions on the surface of the user interface device, and may output a mean of the respective temperatures at the different regions on the surface of the user interface device. In an embodiment, a driving signal may be generated based on sensor data from the temperature/heat flux sensor 160. For instance, the control circuit 130 may be configured to adjust a duration or a magnitude of a portion of the driving signal based on the sensor data. In another embodiment, the temperature/heat flux sensor 160 may be omitted from the user interface device 100D.

In an embodiment, the user interface device 100D may further include a touch sensor 162. For instance, the touch sensor 162 may be a capacitive touch sensor or a resistive touch sensor that is used to form a touch screen on the user interface device 100D. The touch sensor 162 may be used to detect user contact generally on a surface of the user interface device, or on a specific portion of the surface. For instance, the user interface device 100D may also be an embodiment of the user interface device 100A. In this instance, the touch sensor 162 may be configured to detect whether there is user contact specifically at the thermal effect surface portion 105A-1. In an embodiment, the user interface device 100D may use the temperature sensor 160 to sense a touch input on a surface of the user interface device 100D (e.g., at the thermal effect surface portion). For instance, if the temperature sensor 160 detects a temperature between 32° C. and 38° C., then the control circuit 130 may determine that there is user contact at the surface of the user interface device 100D. In some cases, the touch sensor 162 may be omitted.

As stated above, a thermal effect may be triggered by an application. The application may be executing on the user interface device 100, or on another device. FIG. 1F illustrates an embodiment in which the application is executing on another device, namely a computing device 200. More specifically, the figure depicts a system having the user interface device 100 and the computing device 200. For instance, the user interface device 100 may be a handheld game controller, and the computing device 200 may be, e.g., a desktop computer. The computing device 200 may have a storage device 240 that stores an application 244 (e.g., a VR or AR application), and may have a control circuit 230 (e.g., microprocessor) configured to execute the application 244. In an embodiment, the application 244 may request that a thermal effect be generated on the user interface device 100. The control circuit 230 may then transmit the request (e.g., via a wireless communication component) to the user interface device 100. The control circuit 130 of the user interface device 100 may receive the request and control the signal generating circuit 120 based on the request. In some instances, the control circuit 230 may determine one or more characteristics of the driving signal or of the thermal effect, such as a target temperature or a duration, and may communicate the one or more characteristics to the user interface device 100. The control circuit 130 may receive the one or more characteristics and control the signal generating circuit 120 to generate a driving signal having the one or more characteristics, and to generate a thermal effect having the one or more characteristics. In another embodiment, the user interface device 100 may be a standalone device that operates without the computing device 200.

FIG. 1G depicts a user interface device 100E that is an embodiment of the user interface device 100, and that includes a heat dissipation device 170 and a heat transfer component 180. In an embodiment, the heat transfer component 180 may be a layer of thermally conductive material that is configured to conduct heat between the heat pump 110 and a thermal effect surface portion. In an embodiment, the heat transfer component 180 may be located on a side of the heat pump 110 that is closer to the thermal effect surface portion. In an embodiment, the heat dissipation device 170 is configured to dissipate heat. For instance, the heat dissipation device 170 may be located on an opposite side of the heat pump 110 that is farther from the thermal effect surface portion. When the heat pump 110 generates heat flux from a first side closer to the thermal effect surface portion to a second and opposite side, the heat dissipation device 170 may be in contact with the second side of the heat pump 110 and be configured to dissipate heat from the heat flux. For instance, the heat dissipation device 170 may include a load resistor. In an embodiment, the heat dissipation device 170, the heat transfer component 180, or both may be omitted from the user interface device 100E.

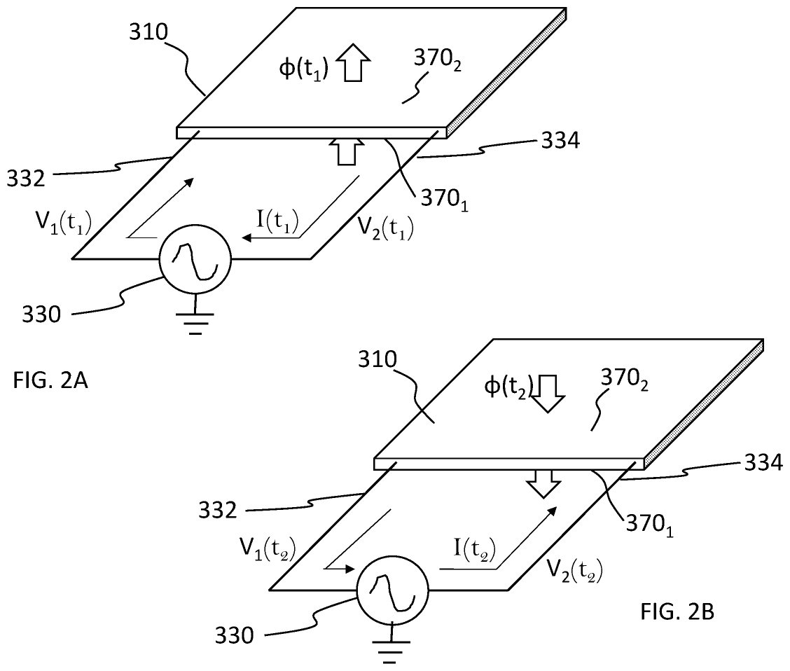

FIGS. 2A and 2B depict a signal generating circuit 330 providing a driving signal to a heat pump 310 that is a thermoelectric device. The driving signal is provided via a first terminal 332 and a second terminal 334 of the thermoelectric device. The driving signal may be a current signal I(t) or a voltage signal V(t). The voltage signal V(t) may refer to a voltage difference between the two terminals, or more specifically a voltage difference between V₁(t) and V₂(t), wherein V₁(t) is a voltage at the first terminal 332, and V₂(t) is a voltage at the second terminal 334, and both V₁(t) and V₂(t) may be with respect to a ground potential. The voltage signal V(t) may also be referred to as a voltage, and may include multiple voltage values that are associated with multiple points in time. Similarly, the current signal I(t) may also be referred to as a current, and may include multiple electrical current values that are associated with multiple points in time. The voltage signal and the current signal may be characterized by a magnitude (e.g., m(t)), which may refer to an absolute value of the voltage values or electrical current values.

FIG. 2A depicts a situation in which the driving signal at time t=t₁ has a first polarity. The first polarity may correspond with, e.g., I(t₁) flowing in a clockwise direction, wherein I(t₁) is the current signal at time t=t₁. The first polarity may also correspond with, e.g., V(t₁) having a negative value, which is caused by V₁(t₁) being less than V₂(t₁) in magnitude (i.e., an absolute value of V₁(t₁) is less than an absolute value of V₂(t₁)). When the driving signal has the first polarity, a heat flux Φ(t₁) in an upward direction may be generated at, e.g., an upper side 370₂ of the thermoelectric device 310, as illustrated in FIG. 2A. More specifically, the heat flux Φ(t₁) may correspond to heat flowing from a bottom side 370₁ of the thermoelectric device 310 to the top side 370₁ thereof, in order to draw heat away from the bottom side 370₁ to the top side 370₂. In some instances, this heat flow may cool the bottom side 370₁ and heat the top side 370₂. If a thermal effect surface portion is closer to the top side 370₂ than to the bottom side 370₁, then the heat flux may flow from the top side 370₂ to the thermal effect surface portion, and may change a heat flux at the thermal effect surface portion (also referred to as a net heat flux) away from a baseline heat flux value. In some cases, the heat flux may heat the thermal effect surface portion so as to raise its temperature above a baseline temperature. In other words, the heat flux between the thermal effect surface portion and the heat pump 310 may be in an upward direction in which heat flows to the thermal effect surface portion and heats the thermal effect surface portion.

FIG. 2B depicts a situation in which the driving signal at time=t₂ has a second polarity opposite to the first polarity. The second polarity may correspond with, e.g., I(t₂) flowing in a counterclockwise direction, wherein I(t₂) is the current signal at time t=t₂. The second polarity may also correspond with, e.g., V(t₂) having a positive value, which is caused by V₁(t₂) being greater than V₂(t₂) in magnitude (i.e., an absolute value of V₁(t₁) is greater than an absolute value of V₂(t₁)). When the driving signal has the second polarity, the heat flux Φ(t₂) at the upper side 370₂ may be in, e.g., a downward direction in which heat flows from the top side 370₂ to the lower side 370₁ of the thermoelectric device to draw heat away from the top side 370₂ and to the lower side 370₁, as depicted in FIG. 2B. In some cases, the heat flux may cool the top side 370₂ and heat the bottom side 370₁. Because the thermal effect surface portion is closer to the top side 370₂ than to the bottom side 370₁, the heat flux from the thermoelectric device may further draw heat from the thermal effect surface portion, which may change a heat flux at the thermal effect surface portion away from a baseline heat flux value. In some cases, such a heat flux may cool the thermal effect surface portion below an baseline temperature. In other words, the heat flux between the thermal effect surface portion and the thermoelectric device may be in a downward direction in which heat is absorbed by the thermoelectric device from the thermal effect surface portion, which may sometimes cool the thermal effect surface portion.

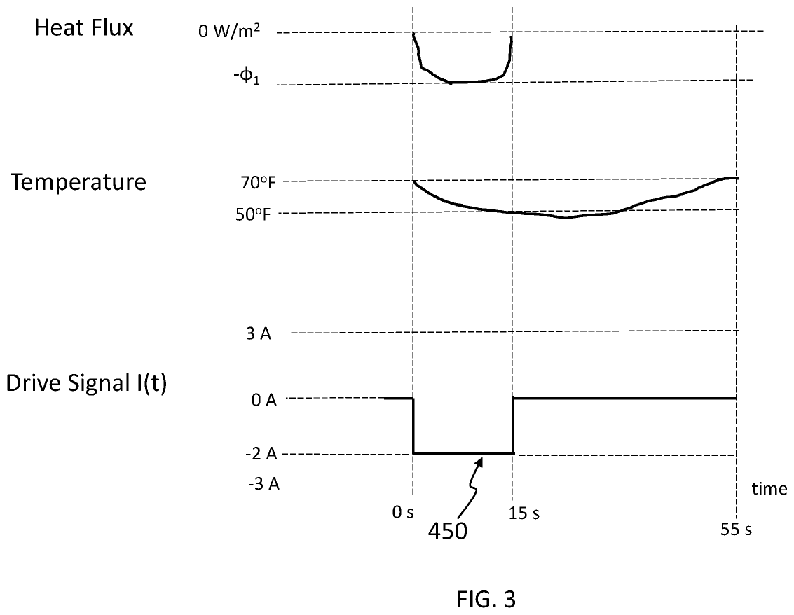

As stated above, a driving signal that does not include a kick-in portion or a braking portion may provide a thermal effect that lacks sharpness. FIG. 3 provides a graph that depicts a driving signal 450 that does not include a kick-in portion or a braking portion. The driving signal 450 may be a current signal I(t), which may be a current flowing between two terminals of a heat pump (e.g., thermoelectric device), such as I(t) in FIG. 2B. As depicted in FIG. 3, the drive signal 450 may have a negative polarity and a magnitude having a constant value of 2 A (wherein the magnitude refers to an absolute value of the driving signal). The graph in FIG. 3 illustrates that the negative polarity of the driving signal 450 may cause a heat flux to be in a negative direction, which may be the downward direction in FIG. 2B. The heat flux in these figures do not account for the baseline heat flux, which may arise from the natural cooling or natural heating due to temperature differences with a surrounding environment. In other words, the value of 0 W/m² in these figures may correspond to the heat pump 110 not generating a heat flux, and to the thermal effect surface portion having a baseline heat flux. FIG. 3 further demonstrates the association between a target temperature and an electrical current value. More specifically, the driving signal 450 may be used to generate a thermal effect having a target temperature of 50° F. As a result, the driving signal 450 may be generated with a electrical current value of −2 A, which is associated with the target temperature in the temperature control profile 142. As stated above, this electrical current value may be referred to as a steady state electrical current value. Using this electrical current value causes the temperature at a thermal effect surface portion (e.g., 105A-1) to change from a baseline temperature of 70° F. to the target temperature of 50° F. in the defined time interval of 15 seconds that is defined in the temperature control profile 142. In another example, the electrical current value may be associated with a target heat flux in the heat flux control profile 143, and causes the heat flux generated by a heat pump to reach a heat flux value associated with the electrical current value, and moves the thermal effect surface portion away from the baseline heat flux.

As depicted in FIG. 3, when the driving signal 450 is applied to a thermoelectric device (e.g., 110), the thermoelectric device may generate a heat flux between itself and a thermal effect surface portion (e.g., 110A-1), wherein a magnitude of the heat flux (i.e., its absolute value) has a constant value of Φ₁. The heat flux causes the thermal effect surface portion to change from the baseline temperature (e.g., 70° F.) to the target temperature of 50° F. in 15 seconds. After the driving signal 450 ends at time t=15 seconds, the temperature at the thermal effect surface portion may naturally rise to the baseline temperature due to a baseline heat flux from natural heat exchange with the surface portion's surrounding environment. This temperature rise, however, may be slow. In the example of FIG. 3, the temperature at the thermal effect surface portion may take about 40 seconds to naturally rise from the target temperature of 50° F. back to the baseline temperature of 70° F. In some cases, the temperature rise may take even longer, such as minutes or tens of minutes. Accordingly, the relatively slow rate of temperature change illustrated in FIG. 3 may limit the sharpness of the thermal effect generated by the driving signal 450.

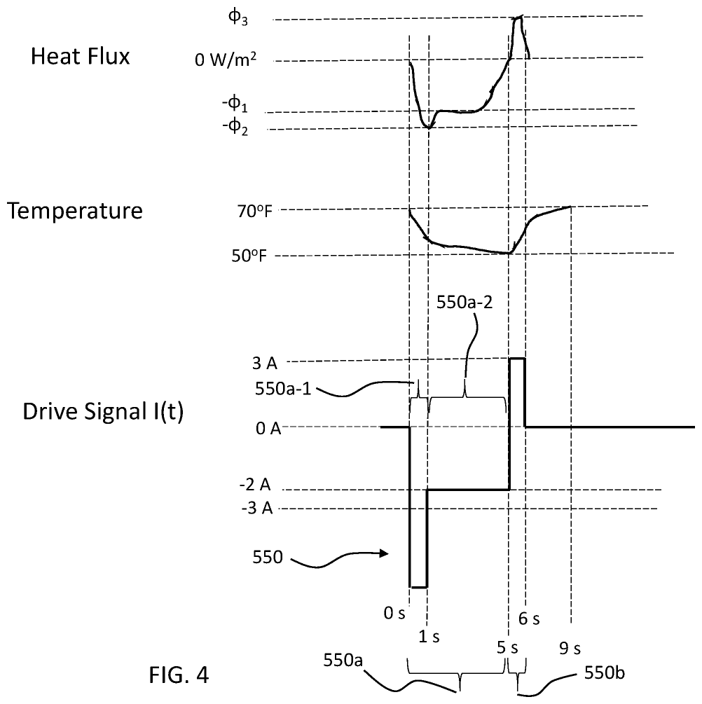

FIG. 4 provides a graph that illustrates a driving signal 550 having a kick-in portion and a braking portion to more quickly generate and stop a thermal effect. The thermal effect in FIG. 4 is a cooling effect, but the features illustrated in the figure also apply a heating effect. The driving signal 550 for generating the cooling effect may have a driving portion 550a and a braking portion 550b. All of the driving portion 550a has a first polarity, such as a negative polarity, and all of the braking portion 550b has a second and opposite polarity, such as a positive polarity. In an embodiment, the braking portion 550b immediately follows the driving portion 550a. The driving portion 550a may be divided into a first sub-portion 550a-1 and a second sub-portion 550a-2, wherein the first sub-portion 550a-1 may act as a kick-in portion, as discussed below in more detail. The first sub-portion 550a-1 may occupy a first time period lasting from t=0 seconds to t=1 second. The second sub-portion 550a-2 may occupy a second time period lasting from t=1 second to t=5 seconds. The braking portion 550b may occupy a third time period lasting from t=5 seconds to t=6 seconds.

As stated above, the first sub-portion 550a-1 may act as a kick-in portion. In an embodiment, the first sub-portion 550a-1 may have a high magnitude. For instance, the thermal effect may have a target temperature, and the first sub-portion 550a-1 may be higher in magnitude than an absolute value of a voltage value or electrical current value associated with the target temperature. In other words, the first sub-portion 550a-1 may be higher in magnitude than a steady state electrical current value associated with a target temperature for the thermal effect. For instance, the thermal effect in FIG. 4 may have a target temperature of 50° F., which is associated with an electrical current value of −2 A in the temperature control profile 142. In this example, the first sub-portion 550a-1 is higher in magnitude than the absolute value of this electrical current value (i.e., higher than 2 A). In other words, a magnitude of the first sub-portion 550a-1, which may be the absolute value of the electrical current value or electrical current values of the first sub-portion, is higher than the absolute value of the electrical current value associated with the target temperature. For instance, the magnitude of the first sub-portion 550a-1 may be a constant electrical current value of 5 A. As a result, the first sub-portion 550a-1 may provide a relatively strong beginning of the driving signal 550 in the first time period. In another example, the thermal effect may have a target heat flux, and the magnitude of the first sub-portion 550a-1 may be higher than the absolute value of the voltage value or electrical current value associated with the target heat flux.

In an embodiment, the relatively strong magnitude in the first period may generate a relatively strong heat flux. For instance, FIG. 4 depicts a magnitude of the heat flux reaching Φ₂, which is greater in magnitude than the heat flux Φ₁ achieved with the driving signal 450 in FIG. 3 or with the second sub-portion 550a-2. In some cases, the greater heat flux 550 in the first time period may generate a greater rate of temperature change in that time period. This greater rate of temperature change is illustrated in the steeper slope by which the temperature in the first time period changes away from the baseline temperature of 70° F., wherein the slope is steeper relative to a rate of temperature change in the second time period, or steeper relative to a rate of temperature change in FIG. 3. As a result, the first sub-portion 550a-1 may act as a kick-in function that helps to quickly generate a thermal effect. For instance, because the first sub-portion 550a-1 increases a rate of temperature change in FIG. 4, the thermal effect therein reaches its target temperature of 50° F. in about 5 seconds, which is shorter and faster than the 15 seconds needed to reach the same target temperature in FIG. 3.

In an embodiment, a magnitude of the first sub-portion 550a-1 may be higher than a defined rated maximum voltage value or defined rated maximum electrical current value for a thermoelectric device (e.g., device 110). In some cases, the defined rated maximum voltage value or the defined rated maximum electrical current value may be a maximum voltage value or maximum electrical current value at which the thermoelectric device can be sustainably operated without overheating the thermoelectric device or otherwise damaging the thermoelectric device. For instance, the defined rated maximum electrical current value in FIG. 4 may be 3 A. In this example, the magnitude of the first sub-portion 550a-1 may have a constant value of, e.g., 5 A, which is higher than the defined rated maximum electrical current value of 3 A (the magnitude of the first sub-portion 550a-1 may refer to an absolute value of the current value(s) of the first sub-portion 550a-1). In another embodiment, the magnitude of the first sub-portion 550a-1 may be equal to the defined rated maximum voltage value or defined rated maximum electrical current value.

In an embodiment, the duration of the first sub-portion 550a-1 may be limited in order to avoid damaging the thermoelectric device. For instance, a duration of the first sub-portion may be limited to no more than 1 second or 2 seconds. In an embodiment, a duration of the first sub-portion may be limited to no more than about 10% of a total duration of the driving portion 550a. In an embodiment, a magnitude of the first sub-portion 550a-1 may have a constant value that does not change over the course of the first time period. In an embodiment, the magnitude of the first sub-portion may change in value over the course of the first time period. In an embodiment, the first sub-portion 550a-1 may be the earliest part of the driving portion 550a. In another embodiment, a driving signal may begin with another portion that is earlier than the first sub-portion 550a-1.

In an embodiment, the second sub-portion 550a-2 in the second time period may immediately follow the first sub-portion 550a-1. In an embodiment, the second sub-portion 550a-2 may be longer in duration than the first sub-portion 550a-1, but may be weaker in magnitude. The weaker magnitude may protect the thermoelectric device (e.g., 110) against overheating, but still drive a temperature change away from an baseline temperature or baseline heat flux, and possibly toward a target temperature or target heat flux. For instance, the second sub-portion 550a-2 in the second time period may generate a heat flux having a magnitude of Φ₁. Although this heat flux of Φ₁ in the second time period is lower in magnitude than the heat flux Φ₂ in the first time period, the heat flux 4i still causes temperature to decrease in the second time period, and thus still contributes to the cooling effect of FIG. 4. In the example of FIG. 4, the second sub-portion 550a-2 may be equal in magnitude to an absolute value of the electrical current value associated with the target temperature. In other words, the second sub-portion 550a-2 may settle to the steady state electrical current value associated with the target temperature. More specifically, the second sub-portion 550a-2 may have a magnitude with a constant value of 2 A, which is equal to an absolute value of the electrical current value (which may also be referred to as a magnitude of the electrical current value) associated with the target temperature (i.e., equal to 2 A). In another embodiment, the second sub-portion 550a-2 may be lower in magnitude than the electrical current value associated with the target temperature. In an embodiment, the first sub-portion 550a-1 and the second sub-portion 550a-2 may be the only sub-portions of the driving portion 550a. In this embodiment, the second sub-portion 550a-2 may immediately precede the driving portion 550b. In another embodiment, the driving portion 550a of the driving signal 550 may have additional sub-portions.

In an embodiment, the braking portion 550b in the third time period causes the thermoelectric device (e.g., 110) to stop a thermal effect by reversing a direction of the heat flux (i.e., reversing the heat flux direction), which may reverse a direction of the temperature change (i.e., reversing the temperature change direction). In particular, the braking portion 550b in FIG. 4 may act to stop the cooling effect, though in another example it may act to stop a heating effect. More specifically, the driving portion 550a occupying the first time period and the second time period may have a negative polarity, and may create a heat flux in a first heat flux direction (e.g., the downward direction in FIG. 2B), which may in some situations cause a temperature at a thermal effect surface portion to change in a first temperature change direction (e.g., a decreasing direction). In other words, the driving portion 550a may cool thermal effect surface portion. In the third time period, the braking portion 550b may have a positive polarity. The positive polarity of the braking portion 550b may cause the heat flux to reverse to a second heat flux direction (e.g., the upward direction in FIG. 2A) and to have a magnitude of Φ₃. The heat flux in the second heat flux direction may cause the temperature at the thermal effect surface portion to change in a second temperature change direction (e.g., an increasing direction) in the third time period. In other words, the braking portion 550b may cause the thermoelectric device to apply heat to the thermal effect surface portion. The heat that is applied may increase a rate at which the temperature at the thermal effect surface portion changes back from the target temperature of 50° F. to the baseline temperature of 70° F. For instance, the braking portion 550b accelerates a change of the temperature of the thermal effect surface portion, with the result that a total amount of time taken to return from the target temperature of 50° F. to the baseline temperature of 70° F. is about 4 seconds. This result is faster than that in FIG. 3, in which the total amount of time taken to return from the same target temperature to the same baseline temperature was about 40 seconds. In an embodiment, the braking portion 550b may cause heat flux at the thermal effect surface portion to more quickly return to a baseline heat flux value.

In an embodiment, the braking portion 550b may have a defined duration, which may be defined in terms of time (e.g., 1 second or 2 seconds), such as depicted in FIG. 4, or in terms of percentage (e.g., 10% of a total duration of the driving portion 550a). In an embodiment, a duration of the braking portion 550b may be equal to a duration of the first sub-portion 550a-1. In an embodiment, the braking portion 550b may continue to be generated and applied until the thermal effect surface portion returns to a baseline temperature or baseline heat flux.

In an embodiment, the braking portion 550b may be greater in magnitude than a voltage value or electrical current value associated with a target temperature. For instance, the magnitude of the braking portion 550b in FIG. 4 may have a constant value of 3 A, which may be greater than a magnitude of the electrical current value associated with the target temperature of 50° F. in the temperature control profile 142 (i.e., greater than 2 A). In an embodiment, the magnitude of the braking portion 550b may have a value that is greater than a magnitude of the electrical current value associated with a target heat flux in the heat flux control profile 143. In the embodiment of FIG. 4, the magnitude of the braking portion 550b is equal to the defined rated maximum electrical current value of 3 A for the thermoelectric device. In another embodiment, the braking portion 550b may be higher in magnitude than the defined rated maximum electrical current value. In other words, a magnitude of the braking portion 550b may be higher than the defined rated maximum voltage or defined rated maximum current. As stated above, the braking portion 550b of FIG. 4 may have a magnitude that is constant over the third time period. In another embodiment, the braking portion 550b may have a magnitude that varies over the third time period.

In an embodiment, one or more characteristics of the driving signal 550 may be based on sensor data from a sensor (e.g., 160), which may be a temperature sensor or a heat flux sensor. The sensor may be located at or near a thermal effect surface portion, and may be configured to measure a temperature of the thermal effect surface portion, or a magnitude and direction of a heat flux at the thermal effect surface portion. The sensor data from the sensor may be temperature data or heat flux data. In an embodiment, the heat flux sensor may measure only heat flux generated by a heat pump, or may measure a net heat flux that accounts for a baseline heat flux at a thermal effect surface portion.

In an embodiment, a magnitude of the first sub-portion 550a-1, a magnitude of the second sub-portion 550a-2, and/or a magnitude of the braking portion 550b may be based on the temperature data and/or the heat flux data. For instance, if a rate of temperature change in the first time period, during which the first sub-portion 550a-1 being applied, is less than a first defined rate threshold, the first sub-portion 550a-1 may be increased in magnitude over the first time period. Similarly, if a rate of temperature change in the third time period, during which the braking portion 550b is being applied, is less than a defined second rate threshold, the braking portion 550b may be increased in magnitude over the third time period. In another example, if a heat flux is less than a first defined heat flux threshold, the first sub-portion 550a-1 may be increased in magnitude over the first time period, and if the heat flux later differs from a baseline heat flux by more than a second defined heat flux threshold, the braking portion 550b may be increased in magnitude over the third time period.

In an embodiment, a duration of the first sub-portion 550a-1, a duration of the second sub-portion 550a-2, and/or a duration of the braking portion 550b may be based on the temperature data and/or the heat flux data. For instance, the first sub-portion 550a-1 may transition to the second sub-portion 550a-2 as soon as the temperature of a thermal effect surface portion reaches a defined temperature threshold, or as soon as a rate of temperature change reaches a defined rate threshold or a heat flux reaches defined heat flux threshold. Similarly, the braking portion 550b may end only when the temperature of the thermal effect surface portion reaches another defined temperature threshold (e.g., the baseline temperature), or only when a rate of temperature change reaches another defined rate threshold, or only when the heat flux reaches another heat flux threshold. In an embodiment, the defined thresholds described above may be stored in a storage device (e.g., 140).

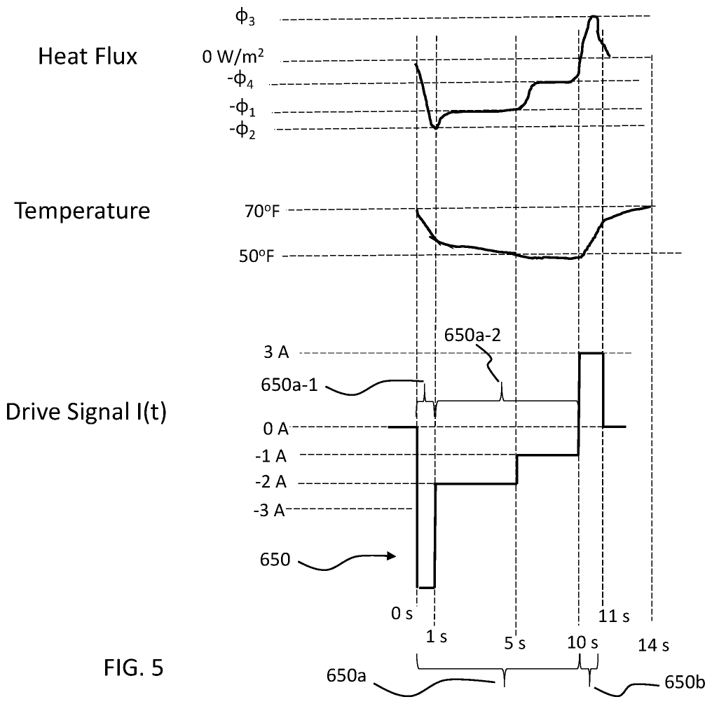

In FIG. 4, the second sub-portion 550a-2 may have a magnitude that is less than or equal to an absolute value of an electrical current value associated with the target temperature of 50° F. (i.e., less than or equal to 2 A), and wherein the magnitude has a constant value over the second time period (the time period lasting from t=1 second to t=5 seconds). FIG. 5 illustrates a driving signal 650 having a second sub-portion 650a-2 whose magnitude is also less than or equal to the absolute value of the electrical current value associated with the target temperature, but the magnitude changes over time. More specifically, like the drive signal 550, the driving signal 650 includes a driving portion 650a and a braking portion 650b that immediately follows the driving portion 650a. The driving portion 650a also has a first sub-portion 650a-1 and a second sub-portion 650a-2. The first sub-portion 650a-1 may occupy a first time period that lasts from t=0 seconds to t=1 second. The second sub-portion 650a-1 may occupy a second time period that lasts from t=1 second to t=10 seconds. The braking portion 650b may occupy a third time period that lasts from t=10 seconds to t=1 seconds. In an embodiment, the first sub-portion 650a-1 may be the same as or similar to the first sub-portion 550a-1, and may function as a kick-in portion.

In an embodiment, the magnitude of the second sub-portion 650a-2 may decrease over the second time period, from an absolute value of the voltage value or electrical current value associated with the target temperature of 50° F. or target heat flux to a lower voltage value or electrical current value. For instance, as stated above, the absolute value of the electrical current value associated with the target temperature of 50° F. is 2 A. Thus, in the example illustrated in FIG. 5, the magnitude of the second sub-portion 650a-2 may begin with an electrical current value of 2 A, and then decrease to an electrical current value of 1 A. FIG. 5 further illustrates the heat flux decreasing in magnitude, from Φ₁ to Φ₄, when the magnitude of the second sub-portion 650a-2 decreases from 2 A to 1 A at t=5 seconds.

In an embodiment, the value to which the magnitude decreases, such as 1 A in FIG. 5, may be a defined value that was experimentally determined to maintain a target temperature of a thermal effect surface portion (e.g., portion 110A-1) or to maintain a target heat flux. For instance, when the magnitude of the second sub-portion 650a-2 is equal to 1 A, the magnitude of the heat flux, Φ₄, may be just enough to counteract the natural heating of the thermal effect surface portion from its surrounding environment. In other words, there may be a natural heat flux between the thermal effect surface portion and its warmer surrounding environment. In such a situation, the heat flux Φ₄ may absorb sufficient heat from the thermal effect surface portion just to counteract the natural heat flux that is providing heat to the thermal effect surface portion. Thus, when the second sub-portion 650a-2 has a magnitude of 1 A, the temperature at the thermal effect surface portion may be maintained without significantly increasing or decreasing.

In an embodiment, the magnitude of the second sub-portion 650a-2 may decrease from an initial value as soon the temperature of the thermal effect surface portion reaches a target temperature or target heat flux. For instance, the magnitude of the second sub-portion 650a-2 decreases from 2 A to 1 A as soon as the temperature reaches the target temperature of 50° F. at t=5 seconds. The magnitude may be decreased to a value that is able to maintain the thermal effect surface portion at the target temperature or target heat flux, as discussed above. In some cases, the second sub-portion 650a-2 may continue to be generated with this value for its magnitude (e.g., at a magnitude of 1 A) until a user removes contact from the thermal effect surface portion. In this scenario, the duration of the second sub-portion 650a-2 may be dictated by the presence of user contact at the thermal effect surface portion. As long as there is user contact, the second sub-portion 650a-2 may cause the thermoelectric device (e.g., 110) to provide a thermal effect that is maintained at a target temperature (e.g., 50° F.). As soon as user contact is removed, the second sub-portion 650a-2 may transition to the braking portion 650b in order to stop the thermal effect and to return the thermal effect surface portion to the baseline temperature or baseline heat flux.

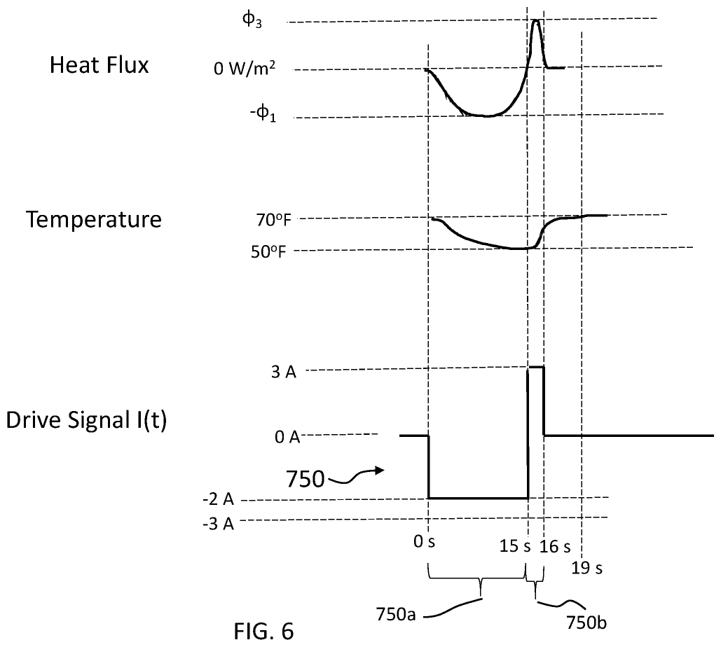

The above embodiments involve a driving signal having a first sub-portion 550a-1/650a-1 that acts as a kick-in portion, wherein the kick-in is higher in magnitude than a steady state electrical current value (e.g., higher than 2 V). FIG. 6 depicts a driving signal 750 that does not have such a kick-in portion, but still includes a braking portion 750b. More specifically, the driving signal 750 includes a driving portion 750a and a braking portion 750b that immediately follows the driving portion 750a. The driving portion 750a may be the same as or similar to the driving signal 450 in FIG. 3. In this embodiment, all of the driving portion 750a may be less than or equal in magnitude to a defined value associated with a target temperature or target heat flux. For instance, the magnitude of the driving portion 750a may have a constant value that is equal to an absolute value of the steady state current value (e.g., equal to 2 A), wherein the steady state current value is the current value associated with the target temperature or target heat flux (e.g., equal to 2 A).

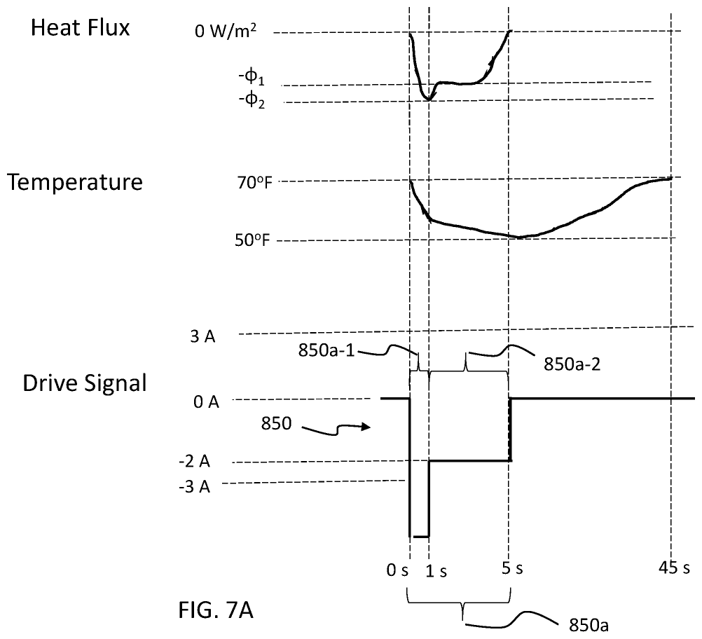

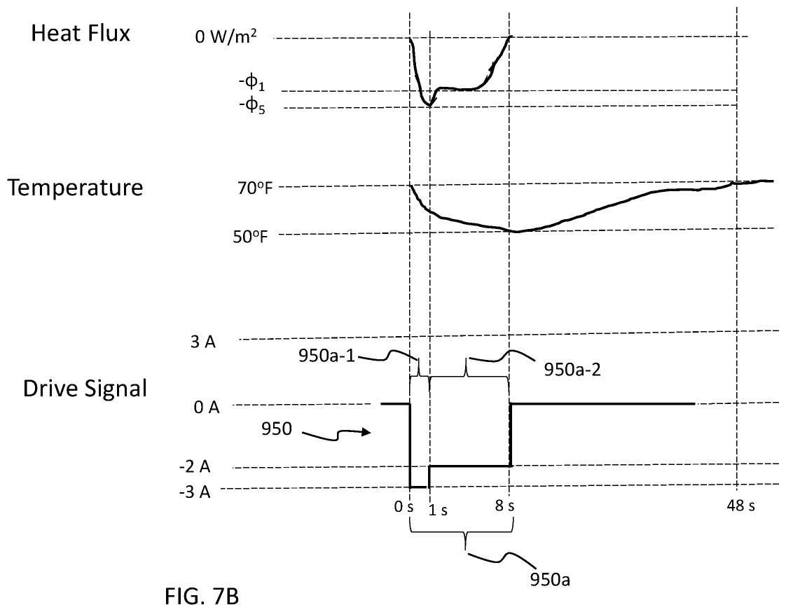

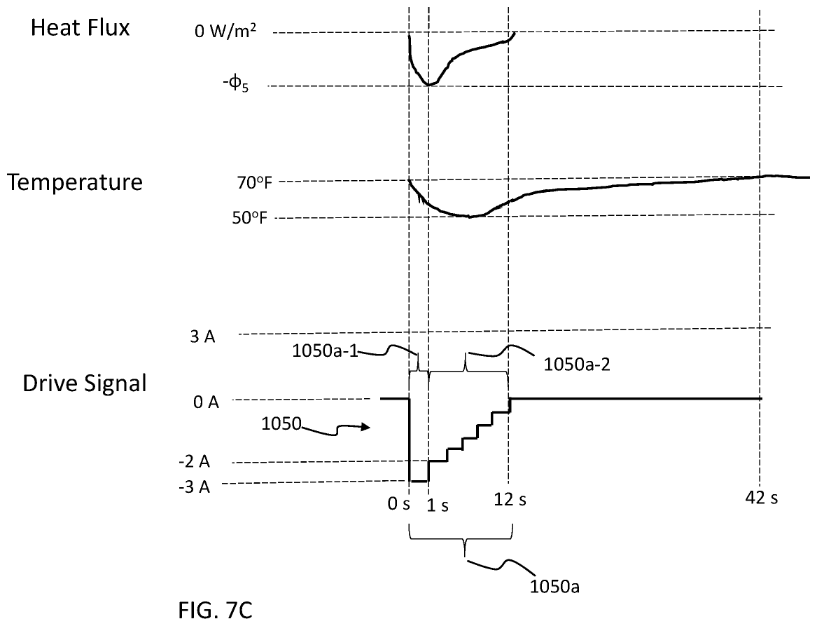

FIG. 7A illustrates a driving signal 850 that does have such a kick-in portion, but that omits a braking portion. More specifically, the driving signal 850 includes only a driving portion 850a. The driving portion 850a may include a first sub-portion 850a-1 and a second sub-portion 850a-2. The first sub-portion 850a-1 may be similar to the first sub-portion 550a-1 in FIG. 4, and may be used as a kick-in portion, while the second sub-portion 850a-2 may be similar to the second sub-portion 550a-2 in the figure. In the embodiment of FIG. 7A, the driving signal 850 may end after the second sub-portion 850a-2.

In FIG. 7A, the first sub-portion 750a-1 may be higher in magnitude than a defined rated maximum electrical current value (e.g., 3 A) of a thermoelectric device. This first sub-portion 750a-1 may cause the thermoelectric device to generate a heat flux having a magnitude of Φ₂. FIG. 7B illustrates a driving signal 950 that also lacks a braking portion, but which has a first sub-portion 950a-1 that is equal in magnitude to the defined rated maximum electrical current value. More specifically, the driving signal 950 may include only a driving portion 950a. The driving portion 950a may be divided into a first sub-portion 950a-1 and a second sub-portion 950a-2. The first sub-portion 950a-1 may have a magnitude with a constant value equal to the defined rated maximum electrical current value (e.g., 3 A) of the thermoelectric device. The first sub-portion 950a-1 may be used as a kick-in portion, and may cause the thermoelectric device to generate a heat flux with a magnitude of Φ₅. The value of Φ₅ may, however, be less than the heat flux value of Φ₂ associated with the kick-in portion of FIG. 7A. As further depicted in the figure, the first sub-portion 950a-1 may be immediately followed by the second sub-portion 950a-2, which may be the same as or similar to the second sub-portion 850a-2.

FIGS. 7A and 7B illustrate a driving signal 850/950 having a second sub-portion 850a-2/950a-2 whose magnitude is constant over time. FIG. 7C depicts a driving signal 1050 that has a second sub-portion 85 whose magnitude decreases over time. More specifically, the drive signal 1050 includes only a drive portion 1050a. The drive portion 1050a has a first sub-portion 1050a-1 and a second sub-portion 1050a-2. The first sub-portion 1050a-1 may be the same as or similar to the first sub-portion 950a-1. The second sub-portion 1050a-1 may have a magnitude that begins with an absolute value of an voltage electrical current value associated with a target temperature or target heat flux (e.g., begins with 2 A), and may include a series of steps that then decreases in value over time. For instance, the magnitude may include 5-20 steps that cumulatively decrease in magnitude from 2 A to 0 A. In an embodiment, the series of steps may allow a thermal effect to more gradually converge toward a target temperature.

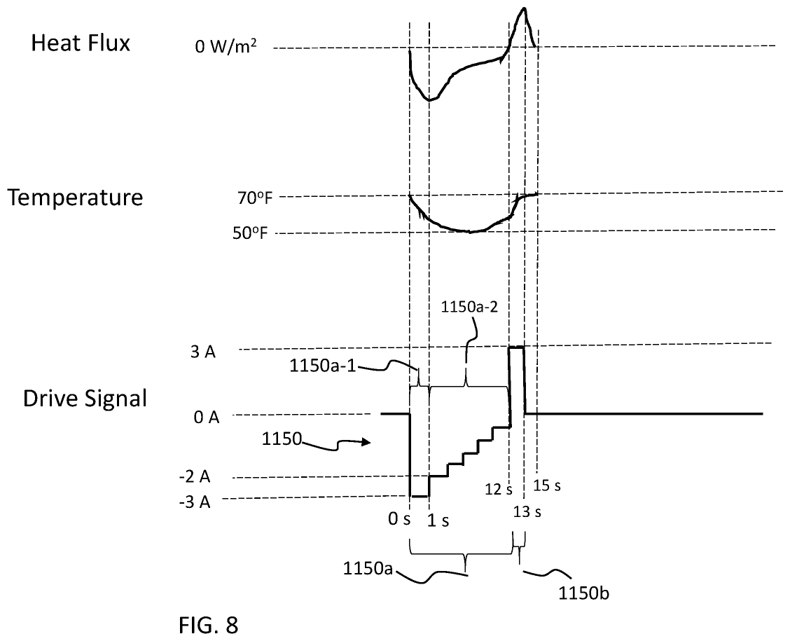

FIG. 8 depicts a driving signal 1150 that is like the driving signal 1050, but further includes a braking portion 1150b. More specifically, the driving signal 1150a includes a driving portion 1150a and the braking portion 1150b, which may immediately follow the driving portion 1150a. The driving portion 1150a may include a first sub-portion 1150a-1 and a second sub-portion 1150a-2, which may be the same as or similar to the first sub-portion 1050a-1 and the second sub-portion 1050a-2, respectively. In an embodiment, the second sub-portion 1150a may be immediately followed by the braking portion 1150b, which may be the same as or similar to the braking portion 550b/650b/750b. As illustrated in FIGS. 7C and 8, the braking portion 1150b may accelerate a return of a temperature from a target temperature to a baseline temperature, or from a target heat flux to a baseline heat flux. More specifically, the driving signal 1050 in FIG. 7C does not have a braking portion. After the driving signal 1050 ends, it may take about 30 seconds for the temperature to naturally return from a target temperature of 50° F. to an baseline temperature of 70° F. By contrast, the driving signal 1150 in FIG. 8 does have a braking portion 1150b. After the driving portion 1150a of the driving signal 1150 ends, the braking portion 1150b may accelerate a return of the temperature toward the baseline temperature to an interval of, e.g., 3 seconds.

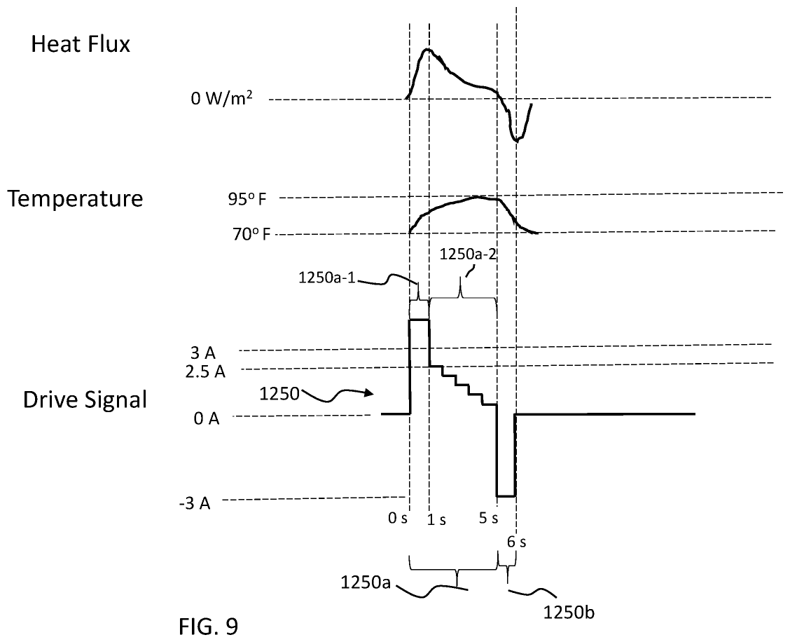

FIG. 9 depicts a driving signal 1250 that may be applied to a thermoelectric device (e.g., 110) to generate a thermal effect that is a heating effect. In an embodiment, the heating effect may have a target temperature of 95° F. The driving signal 1250 may have a driving portion 1250a and a braking portion 1250b that immediately follows the driving portion 1250a. In an embodiment, all of the driving portion 1250a has a positive polarity, while all of the braking portion 1250b has a negative polarity. The driving portion 660a may generate a heat flux in a first heat flux direction (e.g., the upward direction in FIG. 2A), and may increase a temperature of a thermal effect surface portion (e.g., 110B-1). The braking portion 660b may cause the heat flux to reverse to a second heat flux direction (e.g., the downward direction in FIG. 2B), and may decrease the temperature of the thermal effect surface portion.

As illustrated in FIG. 9, the driving portion 1250a may have a first sub-portion 1250a-1 and a second sub-portion 1250a-2. The first sub-portion 1250a-1 may act as a kick-in portion, and may be similar to the kick-in portion 550a-1. For instance, the first sub-portion 1250a-1 may have a magnitude that is higher than an absolute value of a steady state electrical current value, which may be a current value associated with the target temperature of 95° F. or with a target heat flux. In some cases, the magnitude of the first sub-portion 1250a-1 may exceed a defined rated electrical current value (e.g., 3 A) of the haptic effect. The second sub-portion 1250a-2 may be similar to the second sub-portion 1150a-2. For instance, a magnitude of the second sub-portion 1250a-2 may also include a series of steps that decrease over time. Further, all of the second sub-portion 1250a-2 may be less than or equal in magnitude to the steady state electrical current value (e.g., less than 2.5 A).

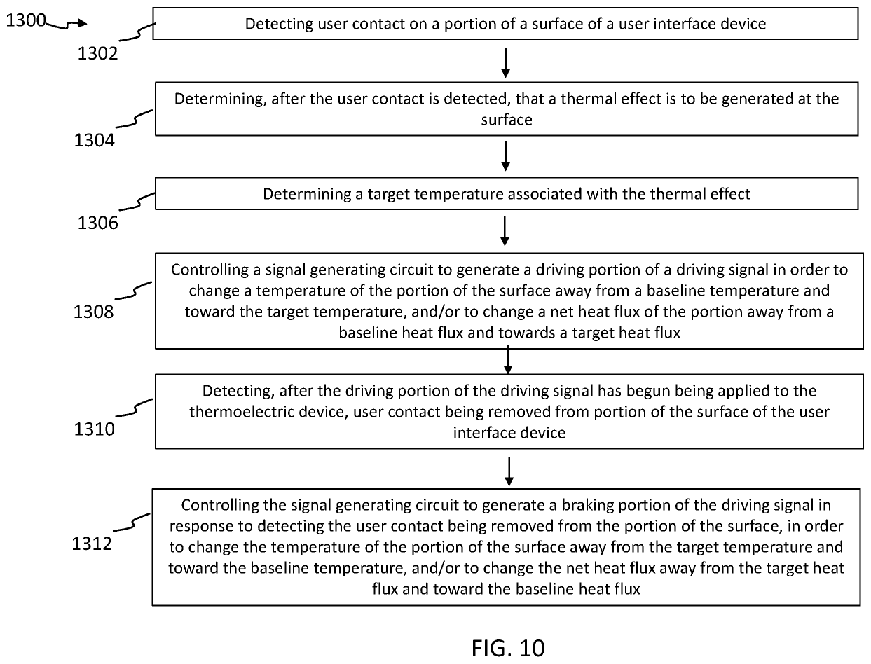

FIG. 10 provides a flow chart illustrating a method 1300 for generating a thermal effect. In some cases, the method 1300 may be performed by the control circuit 130 of the user interface device 100. In such cases, the control circuit 130 may directly control the signal generating circuit 120 to generate a driving signal that is to be applied to a heat pump 110 to generate the thermal effect. In some cases, the method may be performed by the control circuit 230 of the computing device 200. In such cases, the control circuit 230 may indirectly control the signal generating circuit 120 of the user interface device 100, by passing control signals through the control circuit 130.

In an embodiment, method 1300 may begin with a step 1302, in which the control circuit 130/230 detects user contact on a portion of a surface of a user interface device. The portion may also be referred to as a thermal effect surface portion. If the user interface device 100 were the user interface device 100A, such as a mobile phone or tablet computer, the portion may be portion 105A-1 on the outer surface 105A of user interface device 100A. If the user interface device 100 were the user interface device 100B, such as a handheld game controller, the portion may be portion 105B-1 on the outer surface 105B of user interface device 100B. If the user interface device 100 were a wearable device, the portion may be a portion of an inner surface of the wearable device. In some cases, this detecting step may be performed via a resistive touch sensor or capacitive touch sensor, such as the touch sensor 162 of the user interface device 100D. The touch sensor 162 may detect, e.g., any part of a user's hand being in contact with the portion of the surface of the user interface device 100D. In some cases, the detecting step may be performed with the temperature sensor 160. For instance, if the temperature sensor detects a temperature between 32° C. and 38° C., then the control circuit 130 may determine that there is user contact at the surface of the user interface device.

In an embodiment, the portion at which the user contact is detected can be any portion on the surface of the user interface device, or may have to be a specific portion. For instance, step 1302 may involve detecting user contact specifically at the portion 105A-1, which is a portion of the surface 105A directly covering a heat pump 110A of the user interface device 100A. In another example, step 1302 may involve detecting user contact specifically at the portion 105B-1, which is both a portion of the surface 105B directly covering a heat pump 110B, and is an outer surface of a trackpad 106B or other mechanical user input component of the user interface device 100B. In still another example, the user interface device 100 may have a display device that is also a touch screen, and step 1302 may involve detecting user contact on the display device of the user interface device 100, or on a specific portion of the display device. The specific portion may be, e.g., a portion on which a virtual element is being displayed. For instance, the virtual element may be a virtual ice cube that is displayed on a portion of the display device, wherein the user is able to interact with the virtual ice cube by touching that portion of the display device. In such an example, step 1302 may involve detecting whether there is user contact at the portion at which the virtual ice cube is being displayed, wherein a cooling effect associated with the virtual ice cube will be generated only if there is user contact at the portion at which the virtual ice cube is being displayed.

In step 1304, the control circuit 130/230 determines, after the user contact is detected, that a thermal effect is to be generated at the surface of the user interface device, or more specifically at the portion at which user contact is detected. In an embodiment, the thermal effect may be triggered by an application, such as a VR or AR application. For instance, the VR or AR application may determine that a cooling effect should be generated to accompany user interaction with the virtual ice cube in the above example.

In step 1306, the control circuit 130/230 determines a target temperature or target heat flux associated with the thermal effect. In an embodiment, the target temperature may be a temperature assigned to a virtual element by the VR or AR application, such as the virtual ice cube or any other virtual element that is interacting with a user. The target heat flux may be a heat flux to be simulated between the virtual element and a user. In another embodiment, the thermal effect may have no associated target temperature, or no associated target heat flux.

In step 1308, the control circuit 130/230 may control the signal generating circuit 120 to generate a driving portion of the driving signal, such as the driving portion 550a/650a/750a/1150a/1250a of the driving signal 550/650/750/1150/1250. In an embodiment, all of the driving portion 550a/650a/1150a/1250a has a first polarity and causes the heat pump 110 to generate the thermal effect by generating heat flux between the heat pump 110 and the portion of the surface of the user interface device 100, wherein the heat flux may flow in a first direction. The driving portion may cause at least one of a temperature or a net heat flux at the portion of the surface of the user interface device to change away from a baseline temperature or baseline heat flux, respectively, and toward a target temperature or a target heat flux, respectively.

In step 1310, the control circuit 130/230 detects, after the driving portion (e.g., 550a/650a/750a/1150a/1250a) of the driving signal (e.g., 550/650/750/1150/1250) has begun being applied by the signal generating circuit 120 to the heat pump 110, user contact being removed from the portion of the surface of the user interface device 100. In an embodiment, this step may involve detecting the user contact being removed from a specific portion of the surface of the user interface device 100, such as portion 105A-1 or portion 105B-1, while there may still be user contact at other portions of the surface of the user interface device 100. In another embodiment, this step may involve detecting that all user contact has been removed from the surface (e.g., outer surface, inner surface, or both) of the user interface device 100, such that there is no user contact with the surface of the user interface device 100.

In step 1312, the control circuit 130/230 controls the signal generating circuit 120 to generate a braking portion of the driving signal in response to detecting the user contact being removed from the portion of the surface. For instance, the signal generating circuit 120 may generate the braking portion 550b/650b/750b/1150b/1250b of the driving signal 550/650/750/1150/1250. All of the braking portion 550b/650b/750b/1150b/1250b of the driving signal 550/650/750/1150/1250 has a second polarity opposite the first polarity and causes the heat pump 110 to stop the thermal effect by causing the heat flux between the heat pump 110 and the portion (e.g., 105A-1/105B-1) of the surface to flow in a second and opposite direction. The braking portion may cause at least one of the temperature or the net heat flux at the portion of the surface of the user interface device to change away from the target temperature or the target heat flux, respectively, and toward the baseline temperature or the baseline heat flux, respectively. In an embodiment, the braking portion (e.g., 550b/650b/750b/1150b/1250b) immediately follows the driving portion (e.g. 550a/650a/750a/1150a/1250a). In an embodiment, a duration of the braking portion is equal to or less than a duration of the driving portion. For instance, the duration of the braking portion may be equal to or less than 10% of the duration of the driving portion.

In an embodiment, the driving portion of step 1308 may be the driving portion 550a/650a/1150a/1250a, which may include a first sub-portion 550a-1/650a-1/1150a-1/1250a-1 and a second sub-portion 550a-2/650a-2/1150a-2/1250a-2, wherein the first sub-portion 550a-1/650a-1/1150a-1/1250a-1 may act as a kick-in portion. In an embodiment, the control circuit 130/230 may determine a voltage value or a electrical current value associated with the target temperature or target heat flux. For instance, this determination may be based on the temperature control profile 142, which associates target temperatures with respective voltage values or respective electrical current values, or based on the heat flux control profile 143, which associates target heat flux values with respective voltage values or respective electrical current values. In this embodiment, all of the first sub-portion 550a-1/650a-1/1150a-1/1250a-1 may be higher in magnitude than the voltage value or electrical current value associated with the target temperature or target heat flux. In other words, a magnitude of the first sub-portion 550a-1/650a-1/1150a-1/1250a-1 is higher than a magnitude of the voltage value or electrical current value, wherein the magnitude of a value may refer to its absolute value. Further in this embodiment, all of the second sub-portion 550a-2/650a-2/1150a-2/1250a-2 may be equal to or lower in magnitude than the voltage value or electrical current value associated with the target temperature. In an embodiment, the first sub-portion (e.g., 550a-1/650a-1/1150a-1/1250a-1) is shorter than the second sub-portion (e.g., 550a-1/650a-1/1150a-1/1250a-1).

In an embodiment, the heat pump 110 has a defined rated maximum voltage value or rated maximum electrical current value, and a magnitude of the first-sub portion (e.g., 550a-1/650a-1/1150a-1/1250a-1) is higher than or equal to the defined rated maximum voltage value or rated maximum electrical current value.

In an embodiment, each of the first sub-portion (e.g., 550a-1/650a-1/1150a-1/1250a-1), the second sub-portion (e.g., 550a-2/650a-2/1150a-2/1250a-2), and the braking portion (e.g., 550b/650b/1150b/1250b) may have a magnitude that is constant over time, or that changes over time. For instance, the second sub-portion may be the sub-portion 650a-2 or 1150a-2, and a magnitude of the second sub-portion 650a-2/1150a-2 may have a series of steps that decrease in value over time.

In an embodiment, the user interface device 100 is the user interface device 100D, which includes a temperature sensor or heat flux sensor 160 that is configured to generate sensor data indicative of a temperature of the portion of the surface at which there is user contact, or to measure a heat flux at that portion. In this embodiment, the control circuit 130/230 may be configured to control the driving signal based on the sensor data. For instance, the control circuit 130/230 may be configured to control a duration or magnitude of first sub-portion, second sub-portion, or braking portion of the driving signal based on the sensor data. In one example, the control circuit 130/230 may be configured to determine whether the sensor data is less than a defined threshold. The threshold may be, e.g., a defined temperature threshold, a defined rate threshold for a rate of temperature change, or a defined heat flux threshold. If the sensor data is less than the defined threshold, the control circuit 130/230 may control the signal generating circuit 120 to increase a duration of a portion of the driving signal, such as the first sub-portion or the braking portion, or increase a value of the magnitude of that portion of the driving signal.

In an embodiment, the control circuit 130/230 may control the generating circuit 120 to generate a driving signal (e.g., 850/950/1050) that does not have a braking portion, but that has a driving portion (e.g., 850a/950a/1050a) with a first sub-portion (e.g., 850a-1/950a-1/1050a-1) and a second sub-portion (850a-2/950a-2/1050a-2).

In an embodiment, the control circuit 130/230 may control the generating circuit 120 to generate a driving signal (e.g., 550/650/750/850/950/1050/1150/1250) without regard to whether user contact has been detected.

### Additional Discussion of Various Embodiments

One aspect of the present application includes embodiment 1, which is a user interface device comprising a heat pump, a signal generating circuit, and a control circuit. The heat pump is configured to generate a thermal effect at a surface of the user interface device when a driving signal is applied to the heat pump, wherein the thermal effect is at least one of a heating effect or a cooling effect. The signal generating circuit is configured to provide the driving signal to the heat pump. The control circuit is in communication with the signal generating circuit and configured to detect user contact on a portion of the surface of the user interface device, to determine, after the user contact is detected, that the thermal effect is to be generated at the surface, and to determine a target temperature or target heat flux associated with the thermal effect. The control circuit is further configured to control the signal generating circuit to generate a driving portion of the driving signal, wherein all of the driving portion has a first polarity and causes the heat pump to generate the thermal effect by generating heat flux between the heat pump and the portion of the surface of the user interface device, wherein the driving portion causes the heat flux to flow in a first direction, and causes at least one of a temperature or a net heat flux at the portion of the surface of the user interface device to change away from a baseline temperature or baseline heat flux, respectively, and toward a target temperature or a target heat flux, respectively. The control circuit is further configured to detect, after the driving portion of the driving signal has begun being applied by the signal generating circuit to the heat pump, user contact being removed from the portion of the surface of the user interface device. The control circuit is further configured to control the signal generating circuit to generate a braking portion of the driving signal in response to detecting the user contact being removed from the portion of the surface, wherein all of the braking portion of the driving signal has a second polarity opposite the first polarity and causes the heat pump to stop the thermal effect by causing the heat flux between the heat pump and the portion of the surface to flow in a second and opposite direction, wherein the braking portion immediately follows the driving portion, and wherein the braking portion causes at least one of the temperature or the net heat flux at the portion of the surface of the user interface device to change away from the target temperature or the target heat flux, respectively, and toward the baseline temperature or the baseline heat flux, respectively.

Embodiment 2 includes the user interface device of embodiment 1. In this embodiment, the heat pump is a thermoelectric device, and the control circuit is further configured to determine a voltage value or electrical current value that is associated with the target temperature or the target heat flux. The driving portion has a first sub-portion followed by a second sub-portion, wherein all of the first sub-portion is higher in magnitude than the voltage value or electrical current value associated with the target temperature or target heat flux, and wherein all of the second sub-portion is equal to or lower in magnitude than the voltage value or electrical current value associated with the target temperature or target heat flux, wherein the first sub-portion is shorter in duration than the second sub-portion.

Embodiment 3 includes the user interface device of embodiment 2, further comprising a storage device storing a temperature control profile that associates target temperatures with respective voltage values or respective electrical current values, or that associates target heat fluxes with respective voltage value or respective electrical current values, wherein the voltage value or electrical current value associated with the target temperature or the target heat flux is determined based on the temperature control profile.

Embodiment 4 includes the user interface device of embodiment 2 or 3, wherein the thermoelectric device has a defined rated maximum voltage value or rated maximum electrical current value, wherein a magnitude of the first sub-portion has a constant value higher than the defined rated maximum voltage value or rated maximum electrical current value.

Embodiment 5 includes the user interface device of embodiment 4, wherein a magnitude of the braking portion is also higher than the defined rated maximum voltage value or rated maximum electrical current value.

Embodiment 6 includes the user interface device of embodiment 4 or 5, wherein a magnitude of the second sub-portion has a constant value equal to the voltage value or electrical current value associated with the target temperature or target heat flux.

Embodiment 7 includes the user interface device of embodiment 4 or 5, wherein a magnitude of the second sub-portion decreases over time, from an absolute value of the voltage value or electrical current value associated with the target temperature or target heat flux to one or more lower voltage values or electrical current values.

Embodiment 8 includes the user interface device of embodiment 7, wherein the magnitude of the second sub-portion has a series of steps that decrease in value over time.

Embodiment 9 includes the user interface device of any one of embodiments 2-8, wherein the braking portion is shorter than the driving portion in duration, and wherein a duration of the braking portion is equal to a duration of the first sub-portion of the driving portion.

Embodiment 10 includes the user interface device of any one of embodiments 1-8, wherein a duration of the braking portion is equal to or less than 10% of a duration of the driving portion.

Embodiment 11 includes the user interface device of any one of embodiments 1-11, wherein the target temperature or target heat flux is determined based on a temperature or heat flux assigned to a virtual element of a virtual reality application or augmented reality application, wherein the virtual element is interacting with a user via the user interface device.

Embodiment 12 includes the user interface device of any one of embodiments 1-11, further comprising a temperature sensor or a heat flux sensor configured to generate sensor data indicative of a temperature of the portion of the surface of the user interface device or of the net heat flux at the portion of the surface, and wherein the control circuit is configured to receive the sensor data and to control the driving signal based on the sensor data.

Embodiment 13 includes the user interface device of embodiment 12, wherein the control circuit is configured to control at least one of a magnitude of the braking portion or a duration of the braking portion based on the sensor data.

Embodiment 14 includes the user interface device of embodiment 12 or 13, wherein the control circuit is configured to control a duration of the first sub-portion of the driving portion based on the sensor data.

Embodiment 15 includes the user interface device of any one of embodiments 1-14, wherein the heat pump is a Peltier device able to generate the heating effect and able to generate the cooling effect.

Embodiment 16 includes the user interface device of any one of embodiments 1-15, wherein the user interface device is a handheld game controller, and the surface at which the thermal effect is generated is an outer surface of the handheld game controller.

One aspect of the present application includes embodiment 17, which relates to a method of generating a thermal effect at a surface of a user interface device, the thermal effect being at least one of a heating effect or a cooling effect, the method being performed by the user interface device. The method comprises detecting user contact at a portion of the surface of the user interface device. The method further comprises determining, after the user contact is detected at the portion of the surface of the user interface device, that the thermal effect is to be generated at the surface. The method further comprises determining a target temperature or target heat flux associated with the thermal effect, and generating a driving portion of the driving signal, wherein all of the driving portion has a first polarity and causes the heat pump to generate the thermal effect by generating heat flux between the heat pump and the portion of the surface of the user interface device, wherein the driving portion causes the heat flux to flow in a first direction, and causes at least one of a temperature or a net heat flux at the portion of the surface of the user interface device to change away from a baseline temperature or baseline heat flux, respectively, and toward a target temperature or a target heat flux, respectively. The method further comprises applying the driving portion of the driving signal to the thermoelectric device. The method further comprises detecting, after the driving portion of the driving signal has begun being applied to the thermoelectric device, user contact being removed from the portion of the surface of the user interface device. The method further comprises controlling the signal generating circuit to generate the braking portion of the driving signal in response to detecting the user contact being removed from the portion of the surface, wherein all of the braking portion of the driving signal has a second polarity opposite the first polarity and causes the heat pump to stop the thermal effect by causing the heat flux to flow in a second and opposite direction, wherein the braking portion immediately follows the driving portion, and wherein the braking portion causes at least one of the temperature or the net heat flux at the portion of the surface of the user interface device to change away from the target temperature or the target heat flux, respectively, and toward the baseline temperature or the baseline heat flux, respectively.

One aspect of the present application includes embodiment 18, which relates to a user interface device comprising a thermoelectric device configured to generate cooling thermal effect on a surface of the user interface device when a driving signal is applied to the thermoelectric device, wherein the thermal effect is at least one of a heating effect or a cooling effect. The user interface device further comprises a signal generating circuit configured to provide the driving signal to the thermoelectric device. The user interface device further comprises a control circuit in communication with the signal generating circuit and configured to control the signal generating circuit to generate the driving signal to have a driving portion immediately followed by a braking portion, wherein all of the driving portion has a first polarity, and all of the braking portion has a second polarity opposite the first polarity, and wherein the driving portion and the braking portion are the only portions of the driving signal. The driving portion of the driving signal causes the thermoelectric device to generate the thermal effect by generating heat flux between the thermoelectric device and the surface of the user interface device, wherein the driving portion causes the heat flux to flow in a first direction, and causes at least one of a temperature or a net heat flux at the portion of the surface of the user interface device to change away from a baseline temperature or baseline heat flux, respectively, and toward a target temperature or a target heat flux, respectively. Further, the driving portion comprises a first sub-portion followed by a second sub-portion, wherein the first sub-portion is shorter in duration than the second sub-portion, wherein a magnitude of the first sub-portion has a constant first value, and wherein a magnitude of the second sub-portion is lower than the first value. The braking portion causes the thermoelectric device to stop the thermal effect by causing the heat flux to flow in a second and opposite direction, wherein the braking portion immediately follows the driving portion, and is shorter in duration than the driving portion, and wherein the braking portion causes at least one of the temperature or the net heat flux at the portion of the surface of the user interface device to change away from the target temperature or the target heat flux, respectively, and toward the baseline temperature or the baseline heat flux, respectively.

Embodiment 19 includes the user interface device of embodiment 18, wherein the magnitude of the second sub-portion decreases over time to a final value of zero, and wherein the braking portion immediately follows the second sub-portion, the first sub-portion and the second sub-portion being the only sub-portions of the driving portion.

Embodiment 20 includes the user interface device of claim 18 or 19, wherein the user interface device is a wearable device, and the surface at which the thermal effect is generated is an inner surface of the wearable device.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A user interface device comprising:
a heat pump configured to generate a thermal effect at a surface of the user interface device when a driving signal is applied to the heat pump, wherein the thermal effect is at least one of a heating effect or a cooling effect;
a signal generating circuit configured to provide the driving signal to the heat pump;
a control circuit in communication with the signal generating circuit and configured
to detect user contact on a portion of the surface of the user interface device,
to determine, after the user contact is detected, that the thermal effect is to be generated at the surface,
to determine a target temperature or target heat flux associated with the thermal effect, and
to control the signal generating circuit to generate a driving portion of the driving signal, wherein all of the driving portion has a first polarity and causes the heat pump to generate the thermal effect by generating heat flux between the heat pump and the portion of the surface of the user interface device, wherein the driving portion causes the heat flux to flow in a first direction, and causes at least one of a temperature or a net heat flux at the portion of the surface of the user interface device to change away from a baseline temperature or baseline heat flux, respectively, and toward a target temperature or a target heat flux, respectively, and
to detect, after the driving portion of the driving signal has begun being applied by the signal generating circuit to the heat pump, user contact being removed from the portion of the surface of the user interface device,
to control the signal generating circuit to generate a braking portion of the driving signal in response to detecting the user contact being removed from the portion of the surface, wherein all of the braking portion of the driving signal has a second polarity opposite the first polarity and causes the heat pump to stop the thermal effect by causing the heat flux between the heat pump and the portion of the surface to flow in a second and opposite direction, wherein the braking portion immediately follows the driving portion, and wherein the braking portion causes at least one of the temperature or the net heat flux at the portion of the surface of the user interface device to change away from the target temperature or the target heat flux, respectively, and toward the baseline temperature or the baseline heat flux, respectively.

2. The user interface device of claim 1, wherein the heat pump is a thermoelectric device, and wherein the control circuit is further configured to determine a voltage value or electrical current value that is associated with the target temperature or the target heat flux, and
wherein the driving portion has a first sub-portion followed by a second sub-portion, wherein all of the first sub-portion is higher in magnitude than the voltage value or electrical current value associated with the target temperature or target heat flux, and wherein all of the second sub-portion is equal to or lower in magnitude than the voltage value or electrical current value associated with the target temperature or target heat flux, wherein the first sub-portion is shorter in duration than the second sub-portion.

3. The user interface device of claim 2, further comprising a storage device storing a temperature control profile that associates target temperatures with respective voltage values or respective electrical current values, or that associates target heat fluxes with respective voltage value or respective electrical current values, wherein the voltage value or electrical current value associated with the target temperature or the target heat flux is determined based on the temperature control profile.

4. The user interface device of claim 2, wherein the thermoelectric device has a defined rated maximum voltage value or rated maximum electrical current value, wherein a magnitude of the first sub-portion has a constant value higher than the defined rated maximum voltage value or rated maximum electrical current value.

5. The user interface device of claim 4, wherein a magnitude of the braking portion is also higher than the defined rated maximum voltage value or rated maximum electrical current value.

6. The user interface device of claim 4, wherein a magnitude of the second sub-portion has a constant value equal to the voltage value or electrical current value associated with the target temperature or target heat flux.

7. The user interface device of claim 4, wherein a magnitude of the second sub-portion decreases over time, from an absolute value of the voltage value or electrical current value associated with the target temperature or target heat flux to one or more lower voltage values or electrical current values.

8. The user interface device of claim 7, wherein the magnitude of the second sub-portion has a series of steps that decrease in value over time.

9. The user interface device of claim 2, wherein the braking portion is shorter than the driving portion in duration, and wherein a duration of the braking portion is equal to a duration of the first sub-portion of the driving portion.

10. The user interface device of claim 1, wherein a duration of the braking portion is equal to or less than 10% of a duration of the driving portion.

11. The user interface device of claim 1, wherein the target temperature or target heat flux is determined based on a temperature or heat flux assigned to a virtual element of a virtual reality application or augmented reality application, wherein the virtual element is interacting with a user via the user interface device.

12. The user interface device of claim 1, further comprising a temperature sensor or a heat flux sensor configured to generate sensor data indicative of a temperature of the portion of the surface of the user interface device or of the net heat flux at the portion of the surface, and wherein the control circuit is configured to receive the sensor data and to control the driving signal based on the sensor data.

13. The user interface device of claim 12, wherein the control circuit is configured to control at least one of a magnitude of the braking portion or a duration of the braking portion based on the sensor data.

14. The user interface device of claim 12, wherein the control circuit is configured to control a duration of the first sub-portion of the driving portion based on the sensor data.

15. The user interface device of claim 1, wherein the heat pump is a Peltier device able to generate the heating effect and able to generate the cooling effect.

16. The user interface device of claim 1, wherein the user interface device is a handheld game controller, and the surface at which the thermal effect is generated is an outer surface of the handheld game controller.

17. A method of generating a thermal effect at a surface of a user interface device, the thermal effect being at least one of a heating effect or a cooling effect, the method being performed by the user interface device, and comprising:
detecting user contact at a portion of the surface of the user interface device;
determining, after the user contact is detected at the portion of the surface of the user interface device, that the thermal effect is to be generated at the surface;
determining a target temperature or target heat flux associated with the thermal effect;
generating driving portion of the driving signal, wherein all of the driving portion has a first polarity and causes the heat pump to generate the thermal effect by generating heat flux between the heat pump and the portion of the surface of the user interface device, wherein the driving portion causes the heat flux to flow in a first direction, and causes at least one of a temperature or a net heat flux at the portion of the surface of the user interface device to change away from a baseline temperature or baseline heat flux, respectively, and toward a target temperature or a target heat flux, respectively;
applying the driving portion of the driving signal to the thermoelectric device;
detecting, after the driving portion of the driving signal has begun being applied to the thermoelectric device, user contact being removed from the portion of the surface of the user interface device,
causing the signal generating circuit to generate the braking portion of the driving signal in response to detecting the user contact being removed from the portion of the surface, wherein all of the braking portion of the driving signal has a second polarity opposite the first polarity and causes the heat pump to stop the thermal effect by causing the heat flux to flow in a second and opposite direction, wherein the braking portion immediately follows the driving portion, and wherein the braking portion causes at least one of the temperature or the net heat flux at the portion of the surface of the user interface device to change away from the target temperature or the target heat flux, respectively, and toward the baseline temperature or the baseline heat flux, respectively.

18. A user interface device comprising:
a thermoelectric device configured to generate cooling thermal effect on a surface of the user interface device when a driving signal is applied to the thermoelectric device, wherein the thermal effect is at least one of a heating effect or a cooling effect;
a signal generating circuit configured to provide the driving signal to the thermoelectric device;
a control circuit in communication with the signal generating circuit and configured to control the signal generating circuit to generate the driving signal to have a driving portion immediately followed by a braking portion, wherein all of the driving portion has a first polarity, and all of the braking portion has a second polarity opposite the first polarity, and wherein the driving portion and the braking portion are the only portions of the driving signal,
wherein the driving portion of the driving signal causes the thermoelectric device to generate the thermal effect by generating heat flux between the thermoelectric device and the surface of the user interface device, wherein the driving portion causes the heat flux to flow in a first direction, and causes at least one of a temperature or a net heat flux at the portion of the surface of the user interface device to change away from a baseline temperature or baseline heat flux, respectively, and toward a target temperature or a target heat flux, respectively,
wherein the driving portion comprises a first sub-portion followed by a second sub-portion, wherein the first sub-portion is shorter in duration than the second sub-portion, wherein a magnitude of the first sub-portion has a constant first value, and wherein a magnitude of the second sub-portion is lower than the first value, and
wherein the braking portion causes the thermoelectric device to stop the thermal effect by causing the heat flux to flow in a second and opposite direction, wherein the braking portion immediately follows the driving portion, and is shorter in duration than the driving portion, and wherein the braking portion causes at least one of the temperature or the net heat flux at the portion of the surface of the user interface device to change away from the target temperature or the target heat flux, respectively, and toward the baseline temperature or the baseline heat flux, respectively.

19. The user interface device of claim 18, wherein the magnitude of the second sub-portion decreases over time to a final value of zero, and wherein the braking portion immediately follows the second sub-portion, the first sub-portion and the second sub-portion being the only sub-portions of the driving portion.

20. The user interface device of claim 18, wherein the user interface device is a wearable device, and the surface at which the thermal effect is generated is an inner surface of the wearable device.
